(19) United States
(12) Patent Application Publication
(10) Pub. No.: US 2026/0229958 A1
(43) Pub. Date: Aug. 6, 2026

(54) RESIN MOLDED AIR PUMP

(71) Applicant: DANA TM4 INC., Boucherville (CA)

(72) Inventor: Sabahattin DIZDAR, Montreal (CA)

(21) Appl. No.: 19/043,282

(22) Filed: Jan. 31, 2025

(51) Int. Cl. H02K 9/06; H02K 15/121

(52) U.S. Cl. CPC H02K 9/06; H02K 15/121

(57) ABSTRACT

Systems are provided for an electric machine with a rotor loaded with magnets comprising an air pump. An electric machine comprising: a rotor core assembly, the rotor core assembly comprising: a first stack of laminations; a second stack of laminations; a collar, the collar rigidly coupled to the first stack; and an air pump assembly, the air pump assembly comprising the air pump with a plurality of fins comprised of a first molded material bonded to, rigidly coupled to, and that are extended radially from the collar, wherein the air pump is arranged between the first stack and the second stack and in fluid communication with holes of the first stack and the second stack; a stator; and an air gap, wherein the air gap arranged between the stator and the rotor core assembly, and the air gap is arranged between the stator and the air pump.

### TECHNICAL FIELD

The present description relates generally to an electric machine, with a rotor core comprising an air pump with fins comprising resin sandwiched between two stacks of laminations and in fluid communication with holes extending through the rotor core to pump therefrom.

### BACKGROUND AND SUMMARY

A vehicle such as a hybrid vehicle or a fully electric vehicle (EV) may use an electric machine such as a motor for power to drive a vehicle in a direction. The vehicle may use an internal permanent magnet (IPM) electric machine as a motor or as a generator. Each magnetic pole on the rotor is conventionally created by putting permanent magnet material into slots formed in the laminated stack of the rotor. Such slots may not be completely filled with magnetic material, instead being designed to hold a magnet in the center with voids or non-magnetic material at two opposite ends of the slot. An alternating current in the windings of a stator about the rotor core may place force on the magnets. The electro-magnetic force generated by the windings may force a shaft and the other components of the rotor to spin about an axis. The spinning of the rotor converts the electromagnetic energy into rotational energy in the form of torque. A nested V-shaped slot configuration may be used such as from U.S. Pat. No. 7,851,958 and U.S. Pat. No. 7,459,821. Further the motor may be cooled via a work fluid referred to herein as a liquid coolant, such as oil. In particular, coolant may be sprayed, splashed, or applied by some other means to the outer surfaces of the rotor, to remove thermal energy therein.

There is a concern that coolant and/or lubricant for the rotor may become trapped or be housed for an undesired amount of time in an air gap around the rotor and between both the rotor and the stator. An increase in liquid, such as a liquid coolant and/or lubricant, occupying the air gap may increase drag and contribute to other forces opposing the rotation of the rotor, leading to power losses for the electric machine. Further liquid trapped or housed for an undesired amount of time via the air gap, may reduce the rate of thermal energy removal from the rotor. There is a desire to reduce power losses of the electric machine and increase the rate of thermal energy removal from the rotor.

Using a plurality of rotating fins (e.g., involute) may create an air pump that rotates air and creates suction through one or more holes of the rotor. The suction may pull a continuous flow of air and/or other gaseous fluid from the holes and into the pumping section. Further the air flow may push the gaseous fluid radially outward from the pumping section and through the air gap, blowing the liquid coolant out of the air gap. Such fins and other component of air pumps, such as a shim for the fins, are rigidly coupled to the rotor core, such via as one or more of the stacks. The fins, shim, and other components of the air pump may be machined, cast from a metal such as aluminum to reduce weight and therein power losses. Further less magnetic and conductive metals, such as aluminum, may be used for the components of the air pump prevent magnetic flux and electrical current above a threshold through the components of the air pump. However, using aluminum or another metal of a different composition from the stacks of the rotor core may result in thermal expansion mismatch, where the material of the stacks and the materials of the rotor core may expand and contract at different rates when receiving the same amounts of thermal energy. Such thermal expansion mismatches may cause chronic or acute degradation to the components and features of the rotor from thermal energy changes during motor cycles. Creating fins, shims, and other components of the air pump from the same material as a stacks, such as an electrical steel, may reduce or prevent thermal expansion mismatch, but increase weight of the rotor leading to power losses. Further, using an electrically and magnetically conductive material, such as electric steel, for components of the air pump may cause interference, such as flux leakage, with the magnetic fields of the magnets. For example, electrically and magnetically conductive material may interfere with magnets of the rotor if covering them axially. Additional coatings or other features may be added to electrically and magnetically conductive components to prevent interference with the magnets.

The inventors have recognized drawbacks to using aluminum, electric steel, and other materials to comprise the fins and other components of the air pump, such as those described above. The inventors have therein developed an example solution that includes an electric machine comprising: a rotor core assembly, the rotor core assembly comprising: a rotor core assembly, the rotor core assembly comprising: a first stack of laminations; a second stack of laminations; a collar, the collar rigidly coupled to the first stack; and an air pump assembly, the air pump assembly comprising a plurality of fins comprised of a first molded material bonded to, rigidly coupled to, and that extend radially from the collar, wherein the air pump is arranged between the first stack and the second stack and in fluid communication with holes of the first stack and the second stack; a stator; and an air gap, wherein the air gap arranged between the stator and the rotor core, and the air gap is arranged between the stator and the air pump.

The collar and the first and second lamination stacks may comprise the same material, such as electrical steel, and therein have approximately the same coefficient of thermal expansion. The molded material comprising the fins may be of a non-magnetic material. For example, the molded material may be a resin or another type of plastic. Further, the fins may bond to and be continuous with molded material filling a plurality of pockets of the first stack, where the pockets house a plurality of magnets and the molded material filling pockets surrounds, rigidly couples, and bonds the magnets to the first stack. As a plastic, the molded material may have approximately no residual magnetism or reduced residual magnetism below a desired threshold and approximately less electrical and magnetic conductivity compared to other non-magnetic materials. Likewise, as a plastic, the molded material may prevent magnetic interference, such a flux leakage, between the magnets and the molded material or the collar. The fins and a section of the collar sandwiched between the first stack and the second stack, may form an air pump for the electric machine between the first and second stack. When passively rotated, the air pump may rotate air and create suction through a plurality of holes extending through the first stack and/or second stack. The suction may draw gaseous fluid between the fins of the air pump, and the air pump may push the gaseous fluid into the air gap. The gaseous fluid enters the air gap with a blowing force greater than a threshold of force push liquid coolant or other liquid out of the air gap.

Likewise, the example system is scalable, with the collar being rigidly coupled to a plurality of first stacks. Further, the air pump may be sandwiched between a plurality of first stacks and a plurality of second stacks, where holes may extend through the first stacks and/or second stacks. Additionally, the collar may be a first collar and the rotor core assembly comprises a second collar, where the second collar is rigidly coupled to the second stack and the first collar. A plurality of first fins are attached to the first collar, and a plurality of second fins are attached to the second collar, forming the air pump sandwiched between the first stack and the second stack when the first collar and the second collar rigidly coupled therein.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows an example schematic representation of a system, including an electric drive system;

FIG. 2 shows an electric machine system and an end view of an example of an electric machine of the present disclosure;

FIG. 3 shows a schematic diagram and sectional perspective of the electric machine;

FIG. 4A shows a side view of a rotor assembly approximately to scale and a sectional view of a stator schematically housing the rotor assembly;

FIG. 4B shows a side view of an area that includes air pump for the rotor assembly.

FIG. 5 shows a sectional view of the rotor assembly and the pump section.

FIG. 6 shows a sectional view of the rotor assembly and the pump section with magnets and molded material housed within a stack of laminations.

FIG. 7 shows a flow chart of a method for manufacturing the rotor assembly with the air pump section therewithin.

FIG. 8 shows a flow chart of a method for removing a fluid from an air gap between the stator and rotor via the pump section.

### DETAILED DESCRIPTION

The following description relates to systems for a rotor of an electric machine. The rotor of the electric machine comprises a rotor core assembly, where the rotor core assembly comprises at least a rotor core including a plurality of sequentially stacks of laminations, referred to herein as stacks. The stacks are rigidly coupled together to form the rotor cores. Rotor core includes at least a first stack and a second stack, with an air pump sandwiched therebetween and rigidly coupled thereto. The air pump herein is referred to as a pumping section of the rotor core assembly and is an involute with a plurality of fins extending radially outward from at least a shaft and/or a sleeve rigidly coupled to the first and second stacks. The fins comprise a non-electrically conducting and non-magnetic material that may be a polymer, and more specifically a resin. The rotor core assembly includes at least a collar. The collar rigidly couples to the first stack acting as a support the first stack and/or a plurality of other stacks may be positioned around and rigidly couple thereto. Further the collar comprises an extension that is a shaft or sleeve where a plurality of first fins of the pumping section rigidly couples to via bonding. When rigidly coupled to and sandwiched between at least the first stack and second stack, the collar may form the pumping section and the air pump therein.

For example, in this or another embodiment, the inventors have developed a configuration of a solution that includes a rotor core assembly comprising: a first stack of laminations; a second stack of laminations; a first collar, the first collar rigidly coupled to the first stack; a second collar, wherein the second collar rigidly coupled to the second stack; and an air pump assembly, wherein the air pump assembly is formed via at least the first collar, and the air pump assembly including a plurality of fins comprised of a molded material adhesively bonded to, rigidly coupled to, and that is extended radially from the first collar, where the air pump assembly is arranged between the first stack and the second stack.

Each stack may comprise at least a lamination. However, it is to be appreciated that each stack may comprise a plurality of laminations or segments of laminations arranged together to form a lamination sheet and the stack. Further it is to be appreciated that the rotor core assembly may include a plurality of collars, where the collar is a first collar. A second collar that may rigidly couple and support at least the second stack as the first collar rigidly couples to and supports at least the first stack. The second collar includes another pumping section including a plurality of second fins bonded to and extending radially outward from a second extension that is a shaft and/or sleeve. The when the extensions having fins are rigidly coupled, the first collar and the second collar may form the pumping section sandwiched between the first stack and the second stack. Likewise, it is also to be appreciated that there may be a plurality of first stacks and/or a plurality of second stacks on opposite ends of the pumping section rigidly coupled to the pumping section.

An air gap may be arranged between a stator of the electric machine and the rotor core assembly, where the air gap is around the rotor core assembly. The air gap may be around and in fluid communication with the air pump, allowing airflow to be blown from pumping section toward and into the air gap. Said in another way, air flow the pumping section during rotation of the rotor section may plow fluid occupying the air gap out of the air gap and out of contact with surfaces of the stator and the rotor.

Different pluralities of the magnets may be physically coupled and rigidly coupled to each of the assemblies during construction via an over-mold. The molded material of the over-mold may be a polymer (e.g., an over-molded polymer). More specifically, the molded material may be a resin. The stacks of the rotor assemlby may include a plurality of pockets, such as slots, that may house the magnet. The volumes of the pockets un-occcupied by the magnets may be filled with the molded material to form the overmold. There may be a first set of first magnets and a second set of second magnets that physically and rigidly couple to a stack via a plurality of over-molds. The over-molds filling the pockets of stack and coupling the magnets thereto, may be joined to fins of a collar and pumping section rigidly coupled to the stack. The over-molds may comprise the same material as the fins. Said in another way, a first material comprising the fins and a second material comprising over-molds may be a common material. For example, the over-molded polymer may be the same resin or other polymer that the fins comprise. The over-mold comprises a material that reduces magnetic interference, such as flux leakage, between the magnets and the collar rigidly coupled to the stack by having a lower permiability compared to if no overmold were used. Likewise, the over-mold comprises a material that may lack residual magnatism preventing or reducing magnetic interference between the magnets and the over-mold.

For a first example, the first set of magnets, may be housed via a plurality of first slots. For a second example, the first set of magnets may be housed via a plurality of first slots and a plurality of second slots. For these examples, the second magnets may be housed via a plurality of third slots and fourth slots. There may be an outer series of magnets with sub-sets arranged in a V-shape, where the outer series of magnets are radially outward from at least another set of magnets. There may be an inner series of magnets each sub-sets arranged in a V-shape, where the inner series of magnets are radially inward from at least another set of magnets. The rotor core may be of nested V-shaped slot configuration, where the outer slots are nested with the shape of the inner slots. The first set magnets and the second set of magnets may be arranged in a V-shape via a V-shaped structure or structures, such as the slot or a plurality of slots. More specifically, the first set of magnets may include a plurality of sub-sets with each sub-set being arranged in a V-shape. Likewise, the second set of magnets may include a plurality of sub-sets with each sub-set being arranged in a V-shape. The outer set of magnets arranged in a V-shape may be the second set of magnets. The inner set of magnets arranged in a V-shape may be the first set of magnets and may be sandwiched between the second segments and the first segment.

The following description also relates to a method for removing a fluid from the air gap between the stator and rotor via the pump section. During the method, rotation of the pump section via rotation of the rotor passively generates airflow and suction through a plurality of holes of one or more of the stacks of the rotor assembly. A blowing force from the air flow outward from the pump section and into the air gap removes liquid from the air gap.

Further, the following description also relates to another method of assembling the rotor assembly and molding the fins of the pumping section via a molding tool and molding material. The method may use the same molding material for creating the fins of the pumping section and a plurality of over-molds, where the over-molds fill cavities housing magnets and rigidly coupling magnets to a stack including the cavities. The method may join the molding material of the fins and the over-molds via bonding.

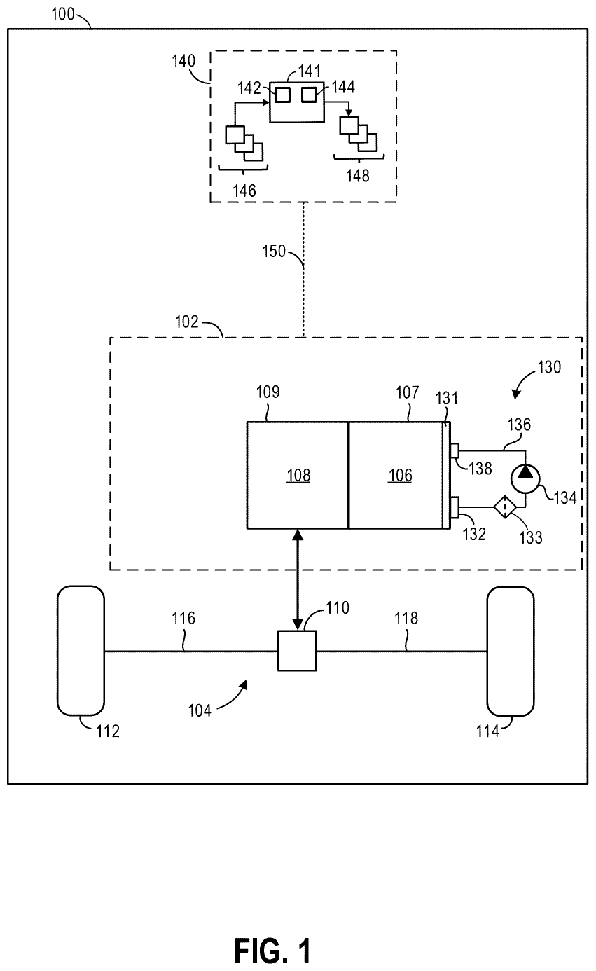

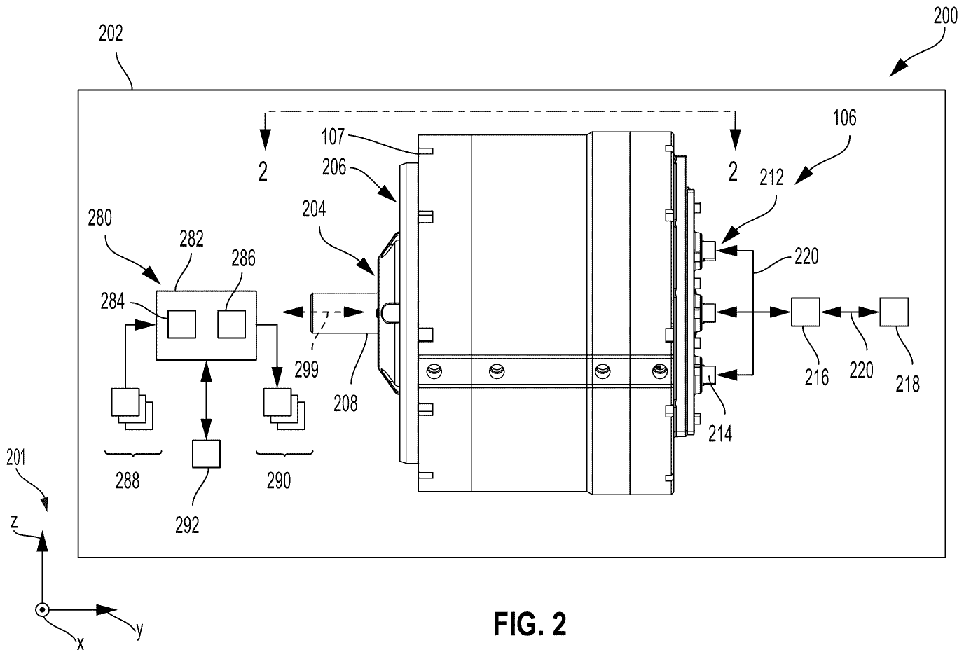

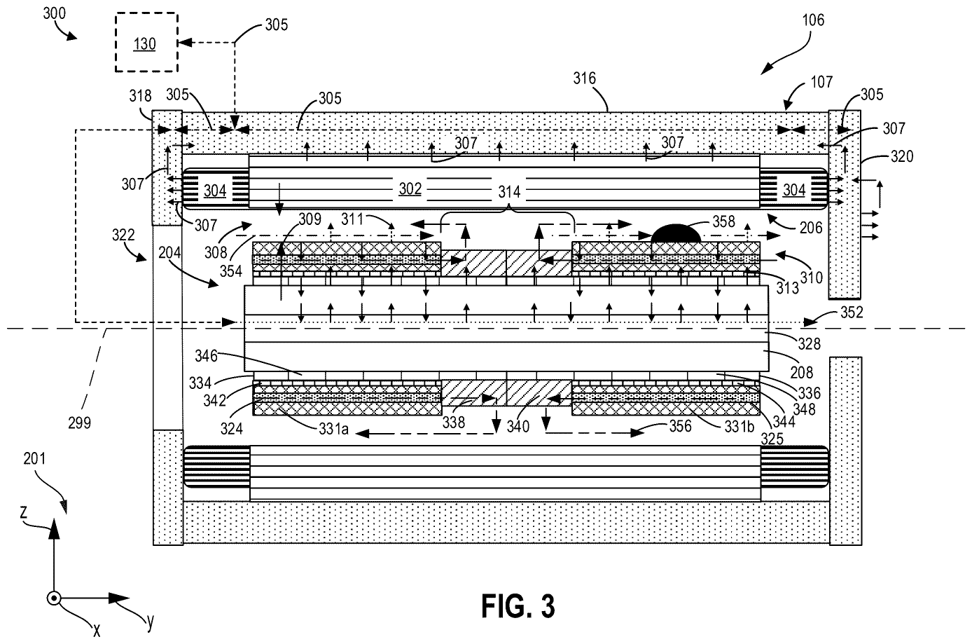

FIG. 1 shows an example schematic representation of a system, including an electric drive system. The electric drive system of FIG. 1 includes an electric machine of the present disclosure, where the electric machine may be an internal permanent magnet (IPM) electric machine with an IPM rotor, and the electric machine may drive the system via mechanical energy. The system of FIG. 1 may be a vehicle. FIG. 2 shows an electric machine system and a side view of an example of an electric machine of the present disclosure. The electric machine of FIG. 2 is the electric machine of FIG. 1. FIG. 3 shows a schematic diagram and sectional perspective of the electric machine. The schematic diagram of FIG. 3 shows an example schematic of stacks of laminations and an air pump of the present disclosure. Further FIG. 3 shows example schematics of collars that form the air pump and that support and rigidly couple to the stacks.

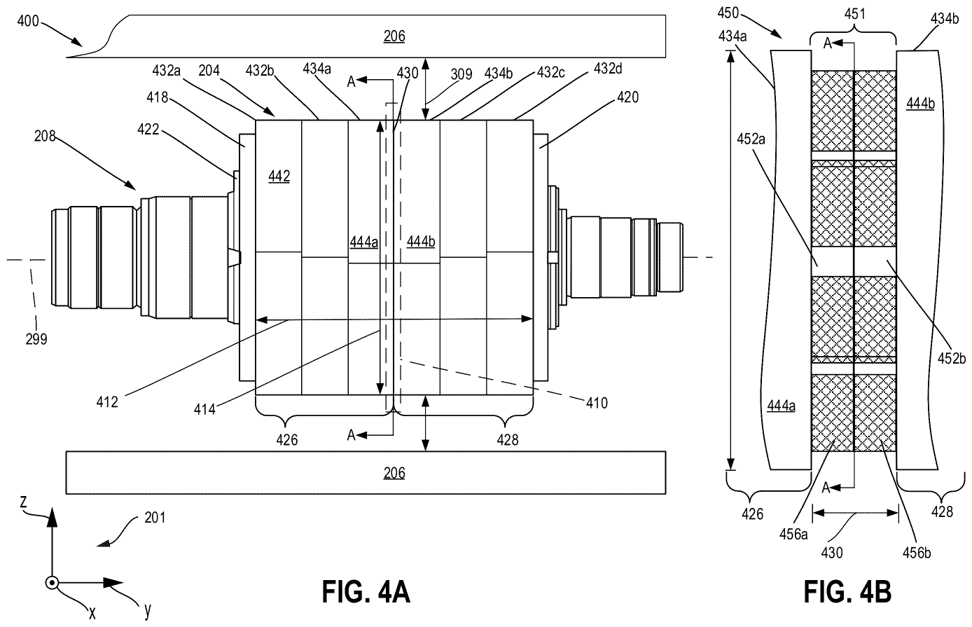

FIG. 4A shows a first side view of a rotor assembly approximately to scale and a sectional view of a stator schematically housing the rotor assembly. FIG. 4A shows a plurality of stacks of laminations for the rotor core positioned around and rigidly coupled to a shaft. Further the FIG. 4A shows a gap between a first set of a stacks and a second set of stacks, where an area surrounds the gap. The FIG. 4B shows a second side view of the that includes an air pump of the present disclosure for the rotor assembly. The second side view is a closer view than the first side view of FIG. 4A, and is taken on the area of FIG. 4A.

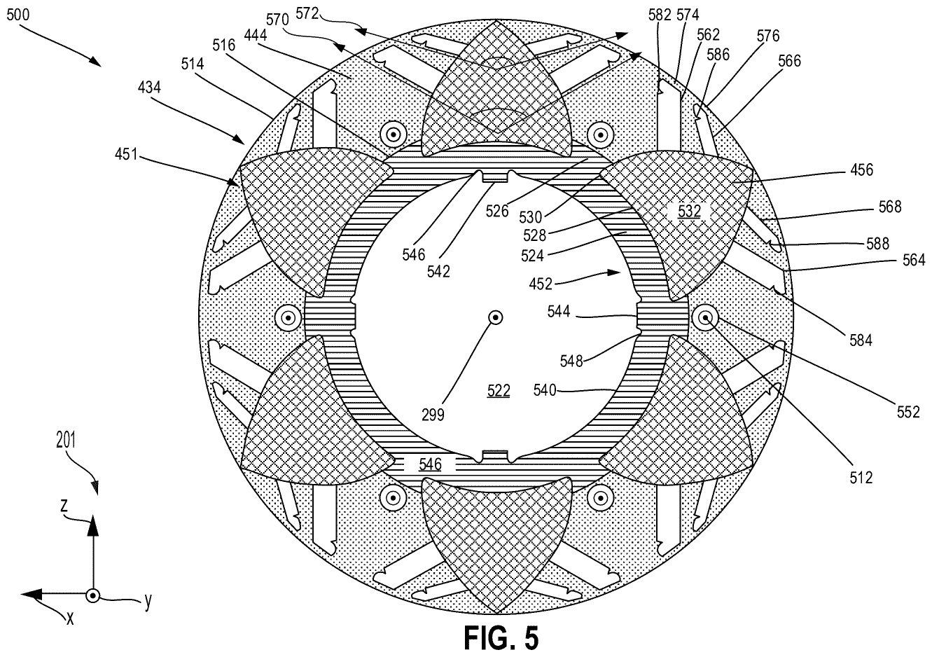

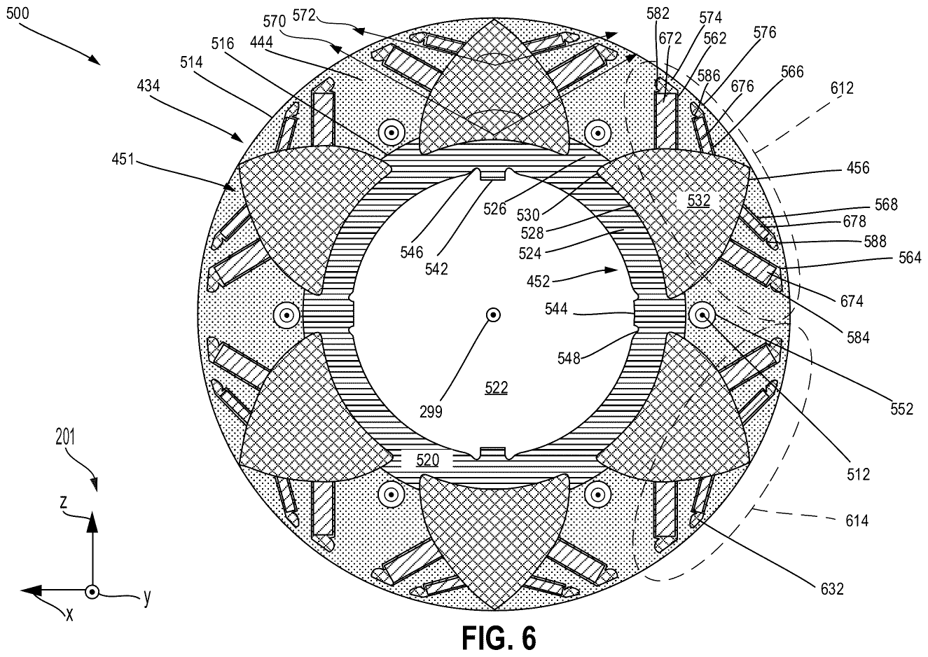

FIG. 5 shows a sectional view of the rotor assembly and the pump section. The sectional view of FIG. 5 shows a stack rigidly coupled to a collar and air pump, and the radially arrangement of the fins of the air pump. Further, FIG. 5 shows a plurality of grooves and grips of a collar that create form locks for the fins to rigidly couple and bond to the collar. The form locks and the features therein may provide mechanical support, such as rigidity, to and increase adhesive bonding to the fins. FIG. 6 shows a sectional view of the rotor assembly and the pump section with a plurality of magnets and plurality of over-mold housed within a stack of laminations. The magnets and over-molds may be housed via a plurality of slots of the stack. Likewise, the material of the over-molds is joined to the material of the fins, such as via bonding.

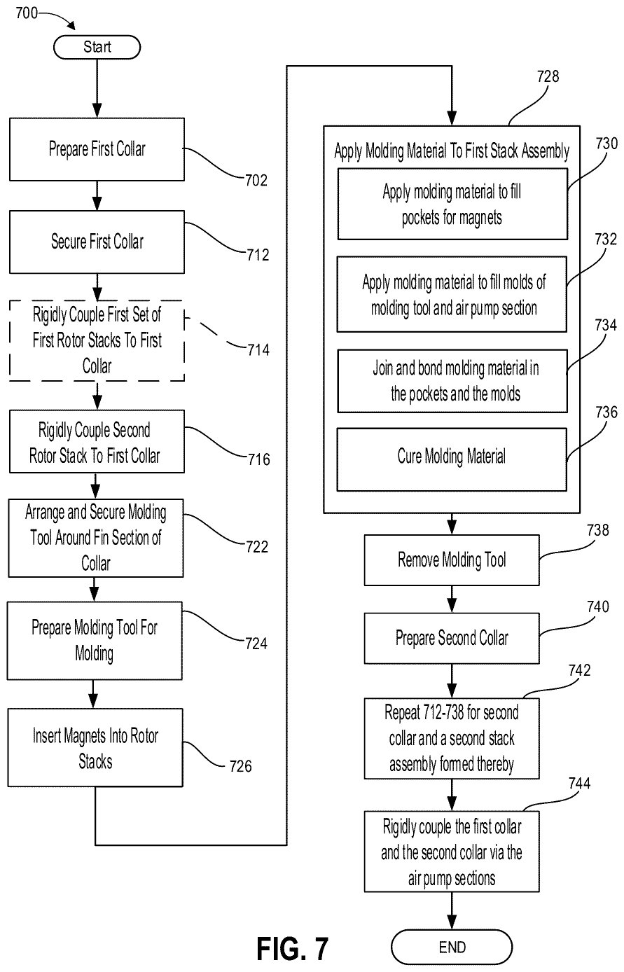

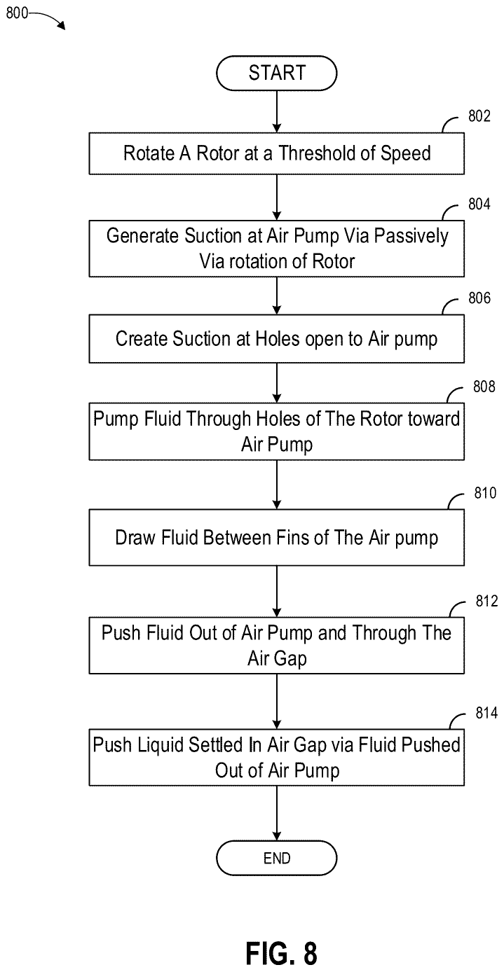

FIG. 7 shows a flow chart of a method for manufacturing the rotor assembly with the air pump section therewithin. The method includes the process of creating the fins for the pumping section via a molding tool. FIG. 8 shows a flow chart of a method for removing a fluid from an air gap between the stator and rotor via the pump section.

FIG. 1 schematically illustrates an electric vehicle 100 with an electric drive system 102 that provides power to and is incorporated into an axle assembly 104 of the vehicle 100. The vehicle 100 may take a variety of forms in different examples, such as a light, medium, or heavy duty vehicle. Additionally, the electric drive system 102 may be adapted for use in front and/or rear axles, as well as steerable and non-steerable axles. To generate power, the electric drive system 102 may include an electric machine 106. In some examples, the electric machine 106 may be an electric motor-generator and may thus include conventional components such as a rotor, a stator, and the like housed within an electric machine housing 107 for generating mechanical power as well as electric power during a regenerative mode, in some cases. Further, in other examples, the vehicle 100 may include an additional motive power source, such as an internal combustion engine (ICE) (e.g., a spark and/or compression ignition engine), for providing power to the axle assembly 104 and the axle therein or to another axle. As such, the electric drive system 102 may be utilized in an electric vehicle (EV), such as a hybrid electric vehicle (HEV) or a battery electric vehicle (BEV).

In some examples, the electric machine housing may be coupled (e.g., via bolts) to a housing of a gearbox. Further, the electric machine may provide mechanical power to a differential via the gearbox. From the differential 110, mechanical power may be transferred to drive wheels 112, 114 by way of axle shafts 116, 118, respectively, of the axle assembly 104. As such, the differential 110 may distribute torque, received from the electric machine 106 via the transmission 108, to the drive wheels 112, 114 of the axle shafts 116, 118, respectively, during certain operating conditions. In some examples, the differential 110 may be a locking differential, an electronically controlled limited slip differential, or a torque vectoring differential. The transmission 108 may be housed via a transmission housing 109.

Alternatively, for another example, the movers and transmissions of the vehicle 100, such as the electric machine 106 and transmission 108, respectively, may output torque directly to a wheel of the vehicle 100, such as either of the wheels 112, 114, where rotary power from the electric machine 106 is prevented from transferring through a differential, such as differential 110. Such an arrangement of movers and transmissions therein be referred to herein as wheel side movers and wheel side transmissions. A mover and a gear train may drivingly couple and output torque to the wheel side transmission, where rotary power may flow from the mover to the gear train and from the gear train to the wheel side transmission. For another example, the mover and the gear train may drivingly couple to one or more wheels of the wheels 112 114. The mover and the gear train may drive one or more wheels, where rotary power may flow from the mover to the gear train and from the gear train to the one or more wheels. For example, of a wheel side configuration of vehicle 100, the vehicle 100 may lack an axle assembly 104. For this example, the transmission 108 may be a wheel side transmission and rigidly couple to a wheel of the wheels 112, 114 via a shaft, such as a shaft of the axle shafts 116, 118.

The transmission 108 may be at least a single-speed transmission, such as a single-speed gearbox, where the transmission 108 operates in one gear ratio. However, other transmission arrangements have been envisioned such as a multi-speed transmission that is designed to operate in multiple distinct gear ratios. For other examples, the transmission 108 may be a two-speed transmission, a three-speed transmission, a four-speed transmission, a five-speed transmission, a six-speed transmission, a seven-speed transmission, an eight-speed transmission, a nine-speed transmission, a ten-speed transmission, an eleven-speed transmission, a twelve-speed transmission, a thirteen-speed transmission, a fourteen-speed transmission, or a fifteen-speed transmission.

In an example, the electric machine 106, the transmission 108, and the differential 110 may be incorporated into the axle assembly 104, forming an electric axle (e-axle) in the vehicle 100. The e-axle, among other functions, for provides motive power to the drive wheels 112, 114 during operation. Specifically, in the e-axle embodiment, the electric machine and gearbox assembly may be coupled to and/or otherwise supported by an axle housing. In one particular example, the e-axle may be an electric beam axle where a solid piece of material (e.g., a beam, a shaft, and/or a housing) extends between the drive wheels. The e-axle may provide a compact arrangement for delivering power directly to the axle. In other examples, however, the electric machine 106 and the transmission 108 may be included in an electric transmission system in which the gearbox and/or electric motor are spaced away from the axle. For instance, in the electric transmission example, mechanical components such as a driveshaft, joints (e.g., universal joints), and the like may provide a rotational connection between the electric transmission and the drive axle.

The electric drive system 102 may further include a heat exchange circuit 130. The heat exchange circuit 130 may circulate a heat exchange fluid that may uptake and eject thermal energy. For example, the heat exchange circuit 130 may be a coolant/cooling circuit that circulates coolant (e.g., water and/or glycol) through a jacket 131. The jacket 131 may therein be a coolant jacket that cools the electric machine via the heat exchange fluid of the heat exchange circuit 130. The electric machine housing 107 may comprise or house the jacket 131. The heat exchange circuit 130 may include a coolant inlet 138 and a coolant outlet 132 positioned on (or in) the electric machine housing 107. The heat exchange circuit 130 may further include a filter 133 and a pump 134 that circulates coolant from the coolant outlet 132 to the coolant inlet 138 via a coolant delivery line 136. From the coolant inlet 138, the coolant travels into the jacket 131 formed in the electric machine housing 107 which removes heat from components of the electric machine 106. In some examples, the heat exchange circuit 130 may further include a heat exchanger (e.g., radiator) which removes heat from the coolant that exits the electric machine housing 107 by way of the coolant outlet 132.

The heat exchange circuit 130 may be a water cooled cooling circuit, where water is used as a coolant, and therein the jacket 131 may be a water jacket. However, it is to be appreciated that the heat exchange circuit 130 may use other forms of coolant to cool the electric machine 106, such as oil. The heat exchange circuit 130 may also be a lubrication circuit, where the heat exchange circuit 130 transports lubricant to lubricate internal components of the electric machine, such as windings and bearings. The lubricant may be oil.

The vehicle 100 may also include a control system 140 with a controller 141. The controller 141 may include a processor 142 and a memory 144. The memory may be non-transitory memory and may hold instructions stored therein that when executed by the processor cause the controller 141 to perform various methods, control techniques, and the like described herein. The processor 142 may include a microprocessor unit and/or other types of circuits. The memory 144 may include known data storage mediums such as random access memory, read only memory, keep alive memory, combinations thereof, and the like. The controller 141 may receive various signals from sensors 146 positioned in different locations in the vehicle 100 and electric drive system 102. The controller 141 may also send control signals to various actuators 148 coupled at different locations in the vehicle 100 and electric drive system 102. For instance, the controller 141 may send command signals the pump 134 and, in response, the actuator(s) in the pump(s) may be adjusted to alter the flowrate of the oil and/or coolant delivered therefrom. The control system 140 and the electric drive system 102 may thus be communicatively coupled, as is indicated by the dotted line 150. In other examples, the controller may send control signals to the electric machine 106 and, responsive to receiving the command signals, the electric machine may be adjusted to alter a rotor speed, such as to increase or decrease the rotational speed of the rotor. The other controllable components in the system may be operated in a similar manner with regard to sensor signals and actuator adjustment.

A set of reference axes 201 are provided for comparison between views shown in FIGS. 2-8C and FIGS. 17-18, for reference. The reference axes 201 indicate a y-axis, an x-axis, and a z-axis. The z-axis may be a vertical axis (e.g., parallel to a gravitational axis), the x-axis may be a lateral axis (e.g., horizontal axis), and/or the y-axis may be a longitudinal axis, in one example. However, the axes may have other orientations, in other examples. The x-y plane may be parallel with a plane that the electric machine 106 may rest upon. When referencing direction, positive may refer to in the direction of the arrow of the y-axis, x-axis, and z-axis and negative may refer to in the opposite direction of the arrow of the y-axis, x-axis, and z-axis. A filled circle may represent an arrow and axis facing toward, or positive to, a view. An unfilled circle may represent an arrow and an axis facing away, or negative to, a view.

A first axis 299 of the electric machine 106 is further provided for reference in FIGS. 2-8C and FIGS. 17-18. The first axis 299 may be a central axis and a rotational axis for the electric machine 106.

Features described as axial may be approximately parallel with an axis referenced unless otherwise specified. Features described as counter-axial may be approximately perpendicular to the axis referenced unless otherwise specified. Features described as radial may circumferentially surround or extend outward from an axis, such as the axis referenced, or a component or feature described prior as being radial to a referenced axis, unless otherwise specified. Unless otherwise specified, the axis referenced may be axis 299.

FIG. 2 shows a first view 200 of an illustration of the electric machine 106. The electric machine 106 may be designed as an electric motor, a generator, or an electric motor-generator and may be included in a system 202 which may take a variety forms. For instance, the electric machine 106 may be incorporated into an electric drive system of an electric vehicle (EV), in one example, such as the vehicle 100 of FIG. 1. As such, the electric machine 106 may be a traction motor and the electric drive may further include a transmission (e.g., gearbox), for instance, such as the electric drive system 102 and the transmission 108 of FIG. 1. In the EV example, the EV may be an all-electric vehicle (e.g., a battery electric vehicle (BEV)), in one example, or a hybrid electric vehicle (HEV) with an internal combustion engine, in another example. However, the electric machine 106 may be used in other suitable systems (e.g., stationary systems), in other examples, such as in industrial machines, agricultural systems, mining systems, and the like.

The electric machine 106 includes a rotor 204 that electromagnetically interacts with a stator 206 to drive rotation of a shaft 208 that is included by or rigidly coupled to the rotor 204. The shaft 208 may rigidly couples to the rotor 204, and therein be a rotor shaft. The electric machine 106 in the illustrated example includes the housing 107 with an electrical interface 212 for the stator 206. The electrical interface 212 may be a multi-phase electrical interface with multiple electrical connectors 214. The electrical interface 212 may be a three-phase interface, in the illustrated example. However, it will be understood that the configuration of the electrical interface 212 may non-limiting. For example, the electrical interface 212 be another multiphase interface, such as a six phase interface or a nine phase interface, in other examples. More generally, the electric machine 106 may be a multi-phase alternating current (AC) machine. More specifically, the electric machine may be an internal permanent magnet (IPM) electric machine with an IPM rotor.

As illustrated in FIG. 2, the first view 200 shows the electric machine 106 may be electrically coupled to an inverter 216. The inverter 216 is designed to covert direct current (DC) power to alternating current (AC) power and vice versa. As such, the electric machine 106 may be an AC electric machine such as an AC electric motor, as indicated above. However, in other examples, the electric machine 106 may be a DC electric motor (as previously indicated) and the inverter 216 may therefore be omitted from the system 202. The inverter 216 may receive electric energy from one or more energy storage device(s) 218 (e.g., traction batteries, capacitors, combinations thereof, and the like). Arrows 220 signify the electric energy transfer between the electric machine 106, the inverter 216, and the energy storage device(s) 218 that may occur during different modes of system operation.

The system 202 may additionally include a control sub-system 280 with a controller 282. The controller 282 includes a processor 284 and memory 286. The memory 286 may hold instructions stored therein that when executed by the processor 284 cause the controller 282 to perform the various methods, control techniques, and the like, described herein. The processor 284 may include a microprocessor unit and/or other types of circuits. The memory 286 may include known data storage mediums such as random access memory, read-only memory, keep alive memory, combinations thereof, and the like.

The controller 282 may receive various signals from sensors 288 positioned in different locations in the system 202. The sensors 288 may include an electric machine speed sensor, energy storage device temperature sensor(s), an energy storage device state of charge sensor(s), an inverter power sensor, and the like. The controller 282 may also send control signals to various actuators 290 coupled at different locations in the system 202. For instance, the controller may send signals to the inverter 216 to adjust the rotational speed of the electric machine 106. In another example, the controller 282 may send a command signal to the electric machine 106 and/or the inverter 216 and in response motor speed may be adjusted. The other controllable components in the system 202 may function in a similar manner with regard to command signals and actuator adjustment.

The system 202 may also include one or more input device(s) 292 (e.g., an accelerator pedal, a brake pedal, a console instrument panel, a touch interface, a touch panel, a keyboard, combinations thereof, and the like). The input device(s) 292, responsive to user input, may generate a motor speed adjustment request.

The system 202 may be the system 140 of FIG. 1. The controller 282 may therein be the controller 141 of FIG. 1, and the processor 284 and the memory 286 may therein respectfully be the processor 142 and memory 144 of FIG. 1. Further the sensors 146 and the various actuators 148 of FIG. 1 may be or include the sensors 288 and various actuators 290.

An example schematic 300 of the electric machine 106 is depicted in FIG. 3. The schematic 300 is a simplified schematic illustration of a cross-section of the electric machine 106. The schematic 300 may be an example schematic representation of a sectional perspective taken of the electric machine 106 taken on the cutting plane 2-2. It will be noted that the cross-section depicts a portion of the electric machine 106. It will be understood that the electric machine 106 includes various additional components that are omitted from FIG. 3 for clarity. The electric machine 106 includes a stator 206, including a stator core 302 with a plurality of end windings 304 protruding axially (e.g., along the central axis of rotation: axis 299) from either end of the stator core 302. The end windings 304 are electrical windings.

A plurality of other windings (e.g., other electrical windings) connected and electrically coupled to the to the end windings 304 may extend through the stator core 302. Electrical current through the other windings may generate electromagnetic forces to rotate the rotor 204.

The stator core 302 may circumferentially surround a rotor 204 of the electric machine 106 and may be spaced away from the rotor 204 via an air gap 308 (e.g., a radial air gap). The air gap 308 may be a distance represented by a plurality of arrows 309. The rotor 204 has a rotor core 310, which may include permanent magnets to generate magnetic flux fields and allow the rotor 204 to rotate at synchronous speeds in response to a supplied current. The rotor core 310 is rigidly coupled to a shaft 208 of the rotor 204, such that the rotor core 310 and the shaft 208 rotate as a single unit. In one example, a length of the shaft 208, as defined along the central axis of rotation (e.g., axis 299), may be greater than a length of the rotor core 310, which may be similar to a length of the stator core 302. The rotor 204 may be formed of different materials depending on an application and a rotor sub-section. For example, the shaft 208 may be formed of steel or a similar metal able to transmit torque and having a desired stiffness. The rotor core 310 of the rotor 204 may comprise high permeability steel with embedded permanent magnets, as an example. Likewise, the stator core 302 may comprise a high permeability steel.

The rotor core 310 includes an air pump section 314, where the air pump section 314 comprises an air pump housed via a gap sandwiched between two sections of laminations of the rotor core 310. Said in another way, the air pump section 314 separates the rotor core 310 into at least a first section of the rotor core and a second section of the rotor core via a gap therebetween and rigidly couples the first section to the second section across the gap. When rotated with the rotor core 310, the air pump section 314 may generate an air flow and suction from the air gap 308 to a plurality of fluid passages of the rotor core 310.

The stator 206 and the rotor 204 may be enclosed within the housing 107 which may include a jacket for heat exchange fluid, such as the jacket 131 of FIG. 1. The housing 107 includes a sleeve portion 316, a first end plate 318, and a second end plate 320, the sleeve portion 316 and the end plates described further below. The housing 107 may entirely surround the stator core 302 and may be formed of a rigid, thermally conductive material, such as aluminum, that is lightweight and low cost as well as mechanically strong and durable. By positioning the housing 107 in direct contact with the stator core 302, heat generated at the stator core 302 may be conducted away from the stator core 302 into the housing 107, as indicated by arrows 307. In some instances, the housing 107 may be air-cooled, transferring heat from the housing 107 to air flowing over the electric machine 106. In other examples, the housing 107 may be liquid-cooled, allowing heat to be exchanged at a coolant flowing through one or more coolant channels of the housing 107.

Heat generated in the rotor core 310 may be a removed via flow of a cooling fluid (e.g., heat exchange fluid), such as oil, and air through the air gap 308 as indicated via arrows 311. Further, additionally, heat generated in the rotor core 310 may be removed via the cooling fluid flowing through fluid passages of the rotor core 310 and shaft 208 as indicated via arrows 313. Heat may be removed from the rotor 204 via conduction and convection of thermal energy through the rotor core 310 to the fluid in the air gap and fluid passages of the rotor core 310 via conduction and convection.

For example, the sleeve portion 316 of the housing 107 may circumferentially surround the stator core 302 along a direction parallel with the central axis of rotation (e.g., axis 299). When the housing 107 is configured to be liquid-cooled, the sleeve portion 316 of the housing 107 may include at least one coolant channel fluidically coupled to the heat exchange circuit 130, for example, a vehicle, as indicated by arrows 305. The housing 107 may also include the first end plate 318 and the second end plate 320, the end plates arranged perpendicular to the central axis of rotation (e.g., axis 299) and coupled to ends of the sleeve portion 316 of the housing 107. The end plates may be formed of a same or different material as the housing 107. In some examples, the end plates may be formed of aluminum to provide high thermal conductivity while maintaining a low weight of the end plates. The first end plate 318 has a central opening 322 (e.g., an opening centered about the axis 299) to accommodate an arrangement of components coupled to the rotor 204, such as bearings, seals, etc.

Inner faces of the first and second end plates 318, 320 may receive the end windings 304 at respective ends of the electric machine 106. However, the end windings 304 may be spaced away from the inner faces of the end plates due to a slotted configuration of the inner faces, as described further below with reference to FIGS. 4A-4C. For example, slots or indentations in the inner faces of the end plates may be aligned with the end windings 304 such that tips of the end windings 304 may be inserted into the slots without contacting the end windings 304, and therefore without exerting any mechanical forces on the end windings 304. Spaces between the end plates and the end windings 304 may be filled with a flexible, thermally conductive potting material to provide mechanical support to the end windings 304 while enabling conductive transfer of heat from the end windings 304 to the end plates.

The first and second end plates 318, 320 may, in one example, be coupled to the sleeve portion 316 of the housing 107, such that the first and second end plates 318, 320 and the housing 107 form a single, continuous unit. Alternatively, the end plates may be separate units from the sleeve portion 316 and may be attached to the sleeve portion 316 by welding, fasteners, etc. The end plates may allow heat to be dissipated from the end windings 304 by conducting heat from the end windings 304 to the sleeve portion 316 of the housing 107, as indicated by arrows 307. In comparison to heat dissipation through the rotor core 310 to the housing 107, heat transfer across the end plates provides additional thermal transfer paths for heat generated at the end windings 304.

In some examples, the end plates each include at least one coolant channel fluidically coupled to the at least one coolant channel of the sleeve portion 316, as indicated by arrows 305, enabling coolant from the heat exchange circuit 130 to be circulated to the end plates, thereby increasing a cooling capacity of the end plates. In yet other examples, only one of the end plates may have the at least one coolant channel and the other end plate may not include coolant channels. In particular, the end plate coupled to the welded set of end windings may be configured with at least one coolant channel due to a tendency for hot spots to be generated at the welded set of end windings. The hot spots may form as a result of a greater length of the welded set of end windings compared to the crown set of end windings, when the conductive windings are the hairpin windings. By configuring the housing 107 with the first and second end plates 318, 320, each configured to receive the end windings 304 of the stator 206, an additional heat flux path may be provided for the stator 206. With the end plates coupled to the sleeve portion 316 of the housing 107, the heat from the end windings 304 may be conducted away from the stator core 302, increasing overall heat dissipation from the stator 206.

The rotor 204 and, more specifically, the rotor core 310 is arranged to flow the heat exchange fluid (e.g., a cooling fluid or coolant) therethrough. Further the electric machine is arranged to coat and flow heat exchange fluid around the rotor 204 and. more specifically, the rotor core 310. During rotation of the rotor 204, the air pump section 314 arranged to blow gaseous fluid from holes and other volumes of the rotor core 310 through the air gap 308.

For example, as shown in FIG. 3, the shaft 208 of the rotor 204 may include a plurality of first channels 324 and a plurality second channels 325 extending along a portion of the length of the rotor core 310. The first channels 324 may be a first set of first holes. Likewise, the second channels 325 may be a second set of second holes. As holes, the first channels 324 and second channels 325 may be through holes. The first channels 324 may be disposed in a portion of the rotor 204 that remains stationary and does not rotate. The first channels 324 and the second channels 325 may be through holes extending from the air pump section 314 to opposite ends of the rotor core 310. The first channels 324 and the second channels 325 may have centerlines parallel with the axis 299 and extend along the length of the rotor 204. The first channels 324, and the second channels 325 are fluid channels (e.g., fluid passages), and more specifically heat exchange channels such as cooling channels. As cooling channels, the first channels 324 and second channels 325 may transport gaseous fluid, such as air, used for cooling the rotor 204 and rotor core 310. Said in another way, a heat exchange fluid may flow through the first and second channels 324, 325 to uptake thermal energy from the rotor 204 and the shaft 208. Further the shaft 208 may be hollow and comprise a through hole 328. The through hole 328 between and in volumetric communication with the opposite ends of the shaft 208. The through hole 328 may also be a fluid passage, that fluid, such as lubricant and/or heat exchange fluid, may be housed by and transported via. For example, oil may flow through the through hole 328.

A second flow of heat exchange fluid through the shaft 208 may be represented via a plurality of third arrows 352 having dotted lines. A third flow of heat exchange fluid through the air gap 308 and through rotor 204 and the rotor core 310 may be represented by a plurality of fourth arrows 354 having dashed and dotted lines. A plurality of a fifth arrows 356 may represent air flow to and suction from the air pump section 314. The plurality of fifth arrows 356 additionally represent air flow out of and blowing of air from the air pump section 314. The second flow represented by the third arrows 352 and the third flow represented by the fourth arrows 354 may be drawn from the first flow represented by arrows 305. Heat exchange fluid may flow through the through hole 328 as shown by the second flow represented by the third arrows 352. Heat exchange fluid may flow around the rotor 204 as shown by the third flow represented by the fourth arrows 354. The suction and airflow represented by the fifth arrows 356 may draw air from volumes between the rotor 204 and stator 206 and/or housing 107, through the first channels 324, the second channels 325, and the rotor core 310, to the air pump section 314. The air and other fluid may be pushed outward, such as radially outward, from the air pump section 314. The air and other gaseous fluid on the fifth path push accumulated fluid 358 out of the air gap 308, where the accumulated fluid 358 occupies and may be trapped via the air gap 308. Said in another way, the accumulated fluid 358 may be blown out between the air gap 308 via air and other gaseous fluid on the fifth path directed pumped through the air gap 308. Said in another way, when the air pump section 314 is rotated at or above a non-zero threshold of rotational speed, the airflow and blowing force therefrom, represented by the fifth arrows 356, may remove the accumulated fluid 358 occupying and trapped within the air gap 308. The accumulated fluid 358 may be of a liquid as shown in FIG. 3, such as one or more of a plurality of droplets. Additionally or alternatively, the accumulated fluid 358 may include or be a coating adhering to one or more surfaces of the rotor 204 and rotor core 310 and/or the stator 206 and stator core 302. The accumulated fluid 358 may be heat exchange fluid and/or lubricant, such as oil. For an example, the accumulated fluid 358 may adhere to one or more surfaces of the rotor 204 facing the air gap 308. Additionally or alternatively, the accumulated fluid 358 may adhere to one or more surfaces of the stator 206 and stator core 302 therein facing the air gap 308.

The rotor core 310 may comprise at least a first stack 331a of laminations, a second stack 331b of laminations, and an air pump assembly, where the air pump assembly includes the air pump section 314 sandwiched therebetween and rigidly coupled thereto. The first stack 331a and the second stack 331b may be arranged radially around the shaft 208. The first stack 331a may be rigidly coupled to and mechanically supported by a first collar 334. Likewise, the second stack 331b may be rigidly coupled to and mechanically supported via a second collar 336. Further, the first collar 334 and the second collar 336 may be rigidly coupled to and/or be arranged radially around the shaft 208. The first channels 324 may extend through the first stack 331a. Likewise, the second channels 325 may extend through the second stack 331b. The first channels 324 and the second channels 325 may be arranged radially within the first stack 331a and the second stack 331b, respectively, may be arranged radially around the axis 299.

The first collar 334 and the second collar 336 may be rigidly coupled to the first stack 331a and the second stack 331b, respectively, via adhesive bonding therebetween. For example, the first collar 334 may be adhesively bonded to the first stack 331a via a first moldable and adhesive material, such as a resin, referred to herein as a first moldable material 342. The first moldable material 342 may be sandwiched between the first stack 331a and the first collar 334. Likewise, the second collar 336 may be adhesively bonded to the second stack 331b via a moldable and adhesive material, such as a resin, referred to herein as a second moldable material 344. The second moldable material 344 may be sandwiched between the second stack 331b and the second collar 336.

The first collar 334 and the second collar 336 may each include a plurality of other laminations that are separate components from the laminations of the first stack 331a and second stack 331b. Said in another way the first collar 334 and the second collar 336 may be laminated with each comprising a plurality of laminations rigidly coupled and stacked in sequence. A first set of other laminations 346 comprising the first collar 334 may be adhesively bonded together to rigidly couple and form the first collar 334. More specifically, the first set of other laminations 346 may be adhesively bonded and rigidly coupled via a moldable and plastic material, such as resin. The moldable material may be sandwiched between each of the other laminations 346 and may be the first moldable material 342. A second set of other laminations 348 comprising the second collar 336 may be adhesively bonded together to rigidly couple and form the second collar 336. More specifically, the second set of other laminations 348 may be adhesively bonded and rigidly coupled via a moldable and plastic material, such as a resin. The moldable material may be sandwiched between each of the other laminations 348 and may be the second moldable material 344.

Each of the laminations of the first stack 331a and the second stack 331b may comprise a plurality of poles. The poles include one or more magnets. The poles may be arranged around a centerline of and a rotational axis of the rotor 204, such as the first axis 299. More specifically, the poles may be arranged radially around the centerline and rotational axis of the rotor 204.

For an example the poles of the laminations may include permanent magnets and include at two sets of poles. The first set of poles are positively charged, where the first set of poles include permanent magnets that are positively charged. The second set of poles are negatively charged, where the second set of poles include permanent magnets that are negatively charged. The poles are positioned radially around the center of the laminations and are approximately equidistant from one another. The poles alternate between poles of the first set and poles of the second set, where radially adjacent poles are of opposite sets. Said in another way, the poles alternate between positively charged and negatively charged, where the radially adjacent poles are of different charges.

The air pump assembly is an assembly of components that form the air pump section 314 for the rotor core 310. The air pump assembly includes the first collar 334 and/or the second collar 336. The air pump assembly and the air pump section 314 is formed via rigidly coupling an end of the first collar 334 to another end of the second collar 336. The air pump assembly and the air pump section 314 includes plurality of fins comprised of a molded material. The molded material of the fins is a polymer, such as a resin or another plastic. The fins may be bonded to, rigidly coupled to, and extend radially from at least the first collar 334. However, additionally or alternatively, it is to be appreciated that the fins may be bonded to, rigidly coupled to, and extend radially from the second collar 336.

For example, the fins of the air pump section 314 may include a plurality of first fins 338 and a plurality of second fins 340. The first fins 338 may be bonded to, rigidly coupled to, and extend radially from the first collar 334. For example, the first fins 338 may be rigidly coupled to first collar 334 and the first stack 331a via adhesive bonding using the first moldable material 342. Further, the first fins 338 may be joined to the first moldable material 342 via chemical bonding, such as polymeric bonding. The first fins 338 may comprise a material of approximately the same composition as the first moldable material 342. Said in another way, the first fins 338 and the first moldable material 342 may comprise a common material. Likewise, the second fins 340 may be bonded to, rigidly coupled to, and extend radially from the second collar 336. For example, the second fins 340 may be rigidly coupled to second collar 336 and the second stack 331b via adhesive bonding using the second moldable material 344. Further, the second fins 340 may be joined to the second moldable material 344 via chemical bonding, such as polymeric bonding. The second fins 340 may comprise a material of approximately the same composition as the second moldable material 344. Said in another way, the second fins 340 and the second moldable material 344 may comprise a common material.

The air pump section 314 and the air pump thereof may be created via the first collar 334, the second collar 336, the first fins 338, and the second fins 340 via rigidly coupling the first collar 334 and the second collar 336 and the first and second stacks 331a, 331b, respectively. The air pump section 314 and the air pump thereof may lack other components and features besides or absent from the first collar 334, the second collar 336, the first fins 338, and the second fins 340. For example, the air pump section 314 and the air pump thereof may be assembled while lacking an air pump shim, such as an aluminum air pump shim, separate from the first collar 334 and the second collar 336.

Turning to FIG. 4A, it shows a second view 400 of an example arrangement of the rotor 204 arranged around, rigidly coupled to, and supported by the shaft 208, and the stator 206 arranged around the rotor 204. The second view 400 is a sectional view and a side view, showing a stator 206 sectioned to show a side of the rotor 204 and shaft 208. The rotor 204 and the shaft 208 shown via FIG. 4A, and components and features therein, are approximately to scale. The stator 206 is shown schematically via FIG. 4A.

The second view 400 shows an area 410 of the rotor 204. The second view 400 shows a length 412 and a width 414 of the rotor 204. The rotor 204 may be arranged such that the length 412 may be parallel with the axis 299 and the width 414 may be perpendicular to the axis 299. Likewise, the width may be a parallel with the z-axis of the reference axes 201. The width 414 may be a diameter for the rotor 204. Area 410 is a first area formed of a plurality of dashed lines that is positioned around a gap 430 of the rotor 204. The gap 430 is separates at least a first stack of laminations and a second stack of laminations of the rotor core of the rotor. The gap 430 may have a diameter equal to the width 414. Likewise, the first stack and the second stack may sandwich the gap 430 and components occupying the gap 430. For the example, in the second view 400, the rotor 204 includes and the gap 430 separates plurality of first stacks 426 and a plurality of second stacks 428 of laminations. The gap 430 may be approximately centered along the length 412 of the rotor. Said in another way, the gap 430 may be approximately centered on a midpoint of the length 412. The rotor core of the rotor 204 may comprise the first stacks 426 and the second stacks 428 and be the rotor core 310 of FIG. 3. The first stacks 426 may rigidly couple to a supporting collar, such as the first collar 334 of FIG. 3. Likewise, the second stacks 428 may rigidly couple to another supporting collar, such as the second collar 336 of FIG. 3. The second view 400 shows a line A-A that may be perpendicular to the axis 299. The line A-A divides the rotor 204 along the gap 430, where the line A-A is parallel with the width 414. A cutting plane may be taken on the line A-A, and a sectional view, such as a sectional view shown in FIGS. 5-6, may be taken on the cutting plane of line A-A.

The rotor 204 may also include a first support 418 and a second support 420. The first support 418 and the second support 420 may be shoulders. Further, a collar for rigidly coupling to and supporting one or more stacks of laminations, such as the first collar 334, may rigidly couple to or comprise the first support 418. Further still, another collar for rigidly coupling to and supporting one or more stacks of laminations, such as the second collar 336, may rigidly couple to or comprise the second support 420. The first support 418 may abut and prevent movement, such as translation, of the first stacks 426. For example, upon abutting the first support 418, the first stacks 426 may be prevented from translating along the axis 299 in a direction toward the first support 418. Likewise, the second support 420 may prevent movement, such as translation, of the second stacks 428. For example, upon abutting the second support 420, the second stacks 428 may be prevented translating of along the axis 299 in a direction toward the second support 420.

The shaft 208 may include one or more shoulders, such as a shoulder 422. The shoulder 422 may be arranged to abut and prevent movement, such as translation, or decoupling of the rotor 204 from the shaft 208. For example, when abutting the shoulder 422, the rotor 204 and, more specifically, the first support 418 may be prevented from translating along the axis 299 in a direction toward the shoulder 422.

The first stacks 426 and the second stacks 428 may include plurality of types of stacks, including two types of stacks referred to herein as A-stacks and B-stacks. B-stacks are adjacent to and face the gap 430, and A-stacks are outward from the B-stacks along the axis 299. The first A-stacks comprise a plurality of laminations 442. The B-stacks comprise a plurality of other laminations, including a plurality of first laminations 444a and second laminations 444b. The first laminations 444a and the second laminations 444b may be non-reversible. For example, the first stacks 426 may include a first A-stack 432a, a second A-stack 432b, and at least a first B-stack 434a. The first A-stack 432a and the first B-stack 434a may be on opposite sides of the second A-stack 432b, with the second A-stack 432b sandwiched therebetween. The second stacks 428 may include a third A-stack 432c, a fourth A-stack 432d, and at least a second B-stack 434b. The fourth A-stack 432d and the second B-stack 434b may be on opposite sides of the third A-stack 432c, with the third A-stack 432c sandwiched therebetween. The first B-stack 434a and the second B-stack 434b are on opposite sides of the gap 430. Said in another way, the gap 430 is sandwiched between the first B-stack 434a and the second B-stack 434b. The first B-stack 434a comprises the first laminations 444a, and the second B-stack 434b comprises the second laminations 444b. The first B-stack 434a may be the first stack 331a of FIG. 3. Likewise, the second B-stack 434b may be the second stack 331b of FIG. 3.

Turning to FIG. 4B it shows a third view 450 taken from the area 410 of FIG. 4A. The third view 450 is a side view of the rotor 204 from a closer perspective.

The third view 450 shows an air pump 451. The gap 430 is positioned around the air pump 451. Likewise, the gap 430 is positioned around sections of a first collar 452a and a second collar 452b. The gap 430 may have a length parallel with the axis 299 greater than a first threshold of length, such as 1 mm. The air pump 451 may be sandwiched between and rigidly coupled to the first B-stack 434a and the second B-stack 434b. The air pump section 314 of FIG. 3 may be or include the air pump 451. The first collar 452a and the second collar 452b may be arranged such as to have lengths parallel with the length 412 and the first axis 299.

The first collar 452a and the second collar 452b may each include a plurality of laminations. Said in another way the first collar 452a and the second collar 452b may be laminated comprising a plurality of laminations rigidly coupled and stacked in sequence. The laminations comprising the first collar 452a may be bonded together to rigidly couple and form the second collar 452b. The laminations of the second collar 452b may be bonded together to rigidly couple and form the second collar 452b. The first collar 452a and the second collar 452b may be the first collar 334 and the second collar 336 of FIG. 3 The first collar 452a and the second collar 452b may be symmetrical (symmetric) and mirror each other. The air pump 451 may include portions of the first collar 452a and the second collar 452b extending outward from the first B-stack 434a and the second B-stack 434b, respectively. The first collar 452a and the second collar 452b may rigidly couple, rigidly coupling the first B-stack 434a and the second B-stack 434b and forming the air pump 451. Likewise, the first collar 452a and the second collar 452b may rigidly couple, rigidly coupling the first stacks 426 and the second stacks 428.

The first collar 452a may rigidly couple to and support at least the first B-stack 434a, where the first B-stack 434a may be positioned around, such as radially around, the first collar 452a. Further the first collar 452a may rigidly couple to and support other stacks of the first stacks 426, where other stacks of the first stacks 426 may be positioned around, such as radially around, the first collar 452a. The second collar 452b may rigidly couple to and support at least the second B-stack 434b. Further the second collar 452 b may rigidly couple to and support other stacks of the second stacks 428, where other stacks of the second stacks 428 may be positioned around, such as radially around, the first collar 452a. The first collar 452a may comprise the same material as laminations of the first stacks 426. Likewise, the second collar 452b may comprise the same material as the second stacks 428. Said in another way the first collar 452a and the first stacks 426 and/or the second collar 452b and second stacks 428 may comprise a common material. For example, the first collar 452a, the second collar 452b, the first stacks 426, and the second stacks 428 may comprise electric steel. The first collar 452a and the first stacks 426 may have approximately the same coefficient of thermal expansion. Likewise, the second collar 452b and the second stacks 428 may have approximately the same coefficient of thermal expansion. Having approximately the same coefficient of thermal expansion between the first collar 452a and the first stacks 426 and/or the second collar 452b and second stacks 428 may reduce or eliminate modes of acute or chronic degradation therebetween, such as degradation via expansion due to heating and/or contraction due to cooling with a coefficient of thermal expansion mismatch.

A plurality of first fins 456a may be arranged radially around, extend radially outward from, and are rigidly coupled to the first collar 452a. Likewise, a plurality of second fins 456b may be arranged radially around, extend radially outward from, and are rigidly coupled to the second collar 452b. The first and second fins 456a, 456b may be the first fins and the second fins of FIG. 3. Likewise, the first and second fins 456a, 456b may comprise a non-magnetic material that is moldable (e.g., a non-magnetic molded material). More specifically, the first and second fins 456a, 456b may comprise a polymer or another plastic, such as a resin or material comprising resin, such as a resin matrix. The first fins 456a and the second fins 456b may have a width parallel to the axis 299 and less than or equal to a threshold of distance. For example, the first fins 456a and the second fins 456b may each have a width less than or equal to threshold of distance, such that combined width of the first fins 456a and the second fins 456b is less than or equal to the length of the gap 430. The widths of the first fins 456a and the second fins 456b may be equal. For example, the width of the first fins 456 a and the second fins 456 b may each have a width of 0.5 mm. When rigidly coupled and/or bonded as part of the air pump, the first fins 456a and the second fins 456b may have a combined width of 1 mm.

FIG. 5 shows a third view 500 of a stack 434 and the air pump 451 of the rotor 204 of FIGS. 2-4B. Additionally, the third view 500 shows a sectional view of a collar 452, where the stack 434 is arranged around and may be rigidly coupled to the collar 452. The third view 500 is a sectional view taken on the line A-A of FIGS. 4A-4B. The stack 434 is a B-stack, and more specifically, may be either the first B-stack 434a or the second B-stack 434b of FIGS. 4A-4B. The collar 452 is a lamination supporting collar of the present disclosure, and may be either the first collar 452a or the second collar 452b of FIGS. 4A-4B. Another stack may be positioned opposite the gap 430 of FIGS. 4A-4B from the stack 434 and be rigidly coupled to the stack 434 via the air pump 451 and collar 452. Further another collar extending from the other stack may be positioned opposite to and rigidly couple to the collar 452. Further the other stack and the other collar may be centered radially around the axis 299 having symmetrical and mirrored features and voids, such as holes and pockets, as the stack 434 and the collar 452.

The collar 452 may be laminated and comprise a plurality of laminations 520. The laminations 520 comprising the collar 452 may be rigidly coupled via a bonding, such as a via a molded material. More specifically, the laminations 520 may be rigidly coupled via bonding through a plastic polymer, such as resin. The laminations 520 may be sequentially stacked along and be positioned radially around the first axis 299.

The third view 500 shows a plurality of second axes 512 that may be parallel with the first axis 299, where the second axes 512 are arranged radially around the first axis 299.

The stack 434 may comprise a lamination 444. The lamination 444 may be a lamination of the first laminations or the second lamination. For an example, the stack 434 may be a unitary structure comprising as single lamination, e.g., the lamination 444, lacking other laminations. However, it is to be appreciated that for other examples, the stack 434 may comprise other laminations additionally or alternatively to the lamination 444. The stack 434 may have at least an outer surface 514 facing radially outward from the stack 434. Likewise, the stack 434 is hollow and may have at least an inner surface 516 facing radially inward from the stack 434. It is to be appreciated, that for other examples the stack 434 may have a plurality of outer surfaces 514 facing radially outward from the first axis 299 and a plurality of inner surfaces 516 facing radially inward toward the first axis 299, such as if the stack 434 comprises a plurality of a laminations. The inner surfaces(s) 516 may be around and form the perimeter of a hole or another passage concentric to the stack 434. The outer surface(s) 514 and the inner surface(s) 516 may be cylindrical in shape. The outer surface(s) 514 and the inner surface(s) 516 may curve radially around the first axis 299. The inner surface(s) 516 may have surface sharing contact with the collar 452.

The air pump 451 includes a plurality of fins 456 rigidly coupled to and extending radially outward from the collar 452. The fins 456 may be the fins 456a or the fins 456b of FIG. 4B. The fins 456 comprise a first material 532. The first material 532 is a non-magnetic moldable material (e.g., a first molded material) molded into the shape of the fins 456. More specifically, the first material 532 is a plastic polymer, such as a resin. The first material 532 may a be molded material used to form the collar 452 and rigidly couple via bonding the laminations 520. The first material 532 may also sandwich between and rigidly couple each of the laminations 520 via adhesive bonding. For an example, the first material 532 may be or be joined to the first moldable material 342 of FIG. 3. Likewise, for another example, the first material 532 may be or may be joined to the second moldable material 344 of FIG. 3.

The sectional view of FIG. 5 shows a stack rigidly coupled to a collar and air pump, and the radially arrangement of the fins of the air pump. Further, FIG. 5 shows a plurality of grooves and grips of a collar that create form locks for the fins to rigidly couple and bond to the collar. The form locks and the features the form locks are formed may provide rigidity and mechanical support to the fins.

The collar 452 may be hollow including a hole 522. The hole 522 may be concentric to the collar 452. Further, the hole 522 may be centered around the first axis 299. The collar 452 may have a plurality of walls 524 that curve radially around the hole 522 and/or the first axis 299. The walls 524 may have one or more inner surface(s) 540 arranged around the hole 522 and may be arranged around the first axis 299. The inner surface(s) 540 may curve around the hole 522.

The collar 452 may include a plurality of grips 526 and a plurality of first grooves 528. The grips 526 may extend radially outward and be arranged radially around other features and components of the collar 452. Surfaces of the grips 526 may have surface sharing contact with the inner surface 516. The first grooves 528 may be arranged radially around the collar 452 and be arrange radially between the grips 526. More specifically, each of the first grooves 528 may be sandwiched between at least a pair of the grips 526. The first grooves 528 may include a plurality of undercuts 530. The undercuts 530 extend into and beneath material of each of the grips 526. A portion of each of the fins 456 may be formed in and housed by a groove the first grooves 528. The first material 532 of the fins 456 may fill the volumes of the grooves including the undercuts 530. The first grooves 528 and the grips 526 may create a form lock between the fins 456 and the collar 452. The grips 526 may contact, abut, and place compressive force on the fins 456, where at least a pair of the grips 526 may be arranged on opposite sides of a fin of the fins 456 to contact, abut, and place compressive force on the fin. Further, the first material 532 of the fins 456 may bond and rigidly couple to the surfaces of the grips 526 and other surfaces of the collar around the first grooves 528. The grips 526 may increase the surface are of surfaces around the first grooves 528 and therein increase adhesion (e.g., the adhesive forces from bonding) between the surfaces around the first grooves 528.

Each of the laminations 520 may include a plurality of the grips 526 and first grooves 528. When each of the grips 526 and each of the first grooves 528 of the laminations 520 aligned such as to be approximately superimposed, the first material 532 may extend in a direction parallel with the first axis 299 along the length of the collar 452, rigidly coupling and mechanically supporting laminations 520 via adhesive bonding.

The collar 452 may include one or more fastening components, such as a plurality of first fastening components 542 and a plurality of second fastening components 544. The first and second fastening components 542, 544 may extend inward toward the first axis 299 from the walls 524 and inner surface(s) 540. For an example, there may be a pair (e.g., two) of the first fastening components 542 extending from the opposite sides of the walls 524 and inner surface(s) 540 across the hole 522. Likewise, there may be a pair of the second fastening components 544 extending from the opposite sides of the walls 524 and inner surface(s) 540 across the hole 522. Each of the first fastening components 542 and each of the second fastening components 544 may be a thread or a tooth. Likewise, each of the first fastening components 542 may insert and fasten to a feature of the shaft 208 of FIGS. 2-4A, such as one or more grooves. Likewise, each of the second fastening components 544 may insert and fasten to a feature of the shaft 208, such as one or more other grooves. Said in another way, the first and/or second fastening components 542, 544 may rigidly couple the shaft 208 to the collar 452.

A plurality of first valleys 546 arranged adjacent to the first fastening components 542. More specifically, the first valleys 546 may be arranged on opposite sides of the first fastening components 542, where at least a pair of first valleys 546 are arranged along opposite sides of the first fastening components 542. A plurality of second valleys 548 may be arranged adjacent to the second fastening components 544. More specifically, the second valleys 548 may be arranged on opposite sides of the second fastening components 544, where at least a pair of the second valleys 548 are arranged along opposite sides of the second fastening components 544.

The stack 434 includes a plurality of holes, pockets, and other volumes that may be arranged radially around the first axis 299, such as when the stack 434 is centered around the first axis 299.

The stack 434 may include a plurality of holes 552 that may be arranged radially around the collar 452, such as when the stack 434 is rigidly coupled to the collar. The holes 552 may be either the first channels 324 or the second channels 325 of FIG. 3. The holes 552 may be arranged to be centered around the second axes 512, such that the holes 552 have centerlines coaxial with the second axes 512. Said in another way, the stack 434 may be arranged such that each of the holes 552 is centered and radially around the second axes 512. The holes 552 may be arranged to be in fluid communication with gaps (e.g., spaces) between the fins 456. Air and other gaseous fluid may flow through the holes 552, such as through the holes 552 and toward the air pump 451 in a direction along the second axes 512.

Likewise, the stack 434 may include a plurality of pockets that may house magnets, such as permanent magnets, of the rotor 204. Said in another way a plurality of magnets may be loaded into a plurality of pockets of the stack 434. There may be a first set of pockets and a second set of pockets, where the second set of pockets are outer pockets arranged radially outward from the first set of pockets, and the first set of pockets are therein inner pockets. Further each set of pockets may be arranged into a plurality of sub sets arranged at angles from one another to be arranged in a V-shaped pattern, (e.g., the sub sets are in a V-shape). Further the second set of pockets may be nested with the first set of pockets. The pockets of the stack 434 may be slots, via which the magnets may be translated into loading the stack 434 therein.

For example, the pockets and slots of the stack 434 may include a first set of slots and a second set of slots, where the second set of slots are arranged radially outward from the first set of slots with respect to the first axis 299. The first set of slots may include a plurality of first slots 562 and plurality of second slots 564. The second set of slots may include a plurality of third slots 566 and a plurality of fourth slots 568. Each of the first slots 562 and second slots 564 may be a separated by a first angle 570, such that each of the first slots 562 and second slots 564 are arranged into a V-shape. Said in another way, each of the first slots 562 and second slots 564 may be paired as sub-set with a V-shape, where the first angle 570 defines the V-shape. Likewise, each of the third slots 566 and fourth slots 568 may be a separated by a second angle 572, such that each of the third slots 566 and fourth slots 568 are arranged into a V-shape. Said in another way, each of the third slots 566 and fourth slots 568 may be paired as a sub-set with a V-shape, where the second angle 572 defines the V-shape. Each of the third and fourth slots 566, 568 may be nested with a pair of the first and second slots 562, 564. The first slots 562, the second slots 564, the third slots 566, and the fourth slots 568 may extend through the stack 434 in a direction parallel with the first axis 299. The stack 434 and the lamination 444 may have a plurality of bridges that may separate slots from the outer surface(s) 514. For example, the stack 434 and the lamination 444 may have a plurality of first bridges 574 separating the first slots 562 and the second slots 564 from the outer surface(s) 514. Likewise, the stack 434 and the lamination 444 may have a plurality of second bridges 576 separating the third slots 566 and the fourth slots 568 from the outer surface(s) 514. The first bridges 574 and the second bridges 576 have surfaces a part of or continuous with the outer surface(s) 514.

The stack 434 and the lamination 444 has a plurality of first members 582 extending into the first slots 562, where each of the first members 582 extends into a volume of a slot of the first slots 562. The stack 434 and the lamination 444 has a plurality of second members 584 extending into the second slots 564, where each of the second members 584 extends into a volume of a slot of the second slots 564. The stack 434 and the lamination 444 has a plurality of third members 586 extending into the third slots 566, where each of the third members 586 extends into a volume of a slot of the third slots 566. The stack 434 and the lamination 444 has a plurality of fourth members 588 extending into the fourth slots 568, where each of the fourth members 588 extends into a volume of a slot of the fourth slots 568. The stack 434 and/or the lamination 444 rigidly couple to or comprise the first members 582, the second members 584, the third members 586, or the fourth members 588.

FIG. 6 shows the third view 500 of the stack 434 radially around and rigidly coupled to collar 452, with the air pump 451 formed thereon, but where the pockets (e.g., the slots 562, 564, 566, 568) house a plurality of over-molds of a second material 632. Likewise, the over-molds and material 632 comprising them are positioned around a plurality of magnets housed via the pockets, filling the volumes of the pockets around the magnets, such as to rigidly couple and bond the magnets to the stack 434. More specifically, the over-molds of the second material 632 may bond and rigidly couple the magnets of the rotor to the lamination 444. Additionally, or alternatively, the over-molds of the second material 632 may bond and rigidly couple the magnets to the laminations of the stack 434. The second material 632 may be the first material 532 comprising the fins 456. Said in another way, the first material 532 and the second material 632 may be a common material sharing approximately the same composition. The first material 532 and/or second material 632 may rigidly couple the stack 434 and the laminations thereof to the collar 452 and the laminations 520 thereof via adhesive bonding. For an example, the second material 632 may be or may be joined to the first moldable material 342 of FIG. 3. Likewise, for another example, the second material 632 may be or may be joined to the second moldable material 344 of FIG. 3.

The stack 434 and the lamination 444 and the include a plurality of poles, where magnets loaded therein may form the poles. Each of the poles include one or more magnets. The poles may be arranged around a centerline of the rotor 204 and a rotational axis, such as the first axis 299. More specifically, the poles may be arranged radially around the centerline and the rotational axis of the stack 434.

For an example the poles of the stack 434 and the lamination 444 may include permanent magnets and include two sets of poles. There may be a first set of first poles 612. There may be a second set of second poles 614. The first poles 612 and second poles 614 are positioned radially around the center of the stack 434 and a rotational axis such as the first axis 299. The first poles 612 may be positively charged and the second poles 614 may be negatively charged, or vice versa. The poles alternate between first poles 612 and second poles 614, where radially adjacent poles are of opposite (e.g., a first pole of the first poles is radially adjacent to second poles). The each of first poles 612 may be approximately equidistant from a pair of second poles 614 adjacent thereto, and vice versa. Said in another way, the poles alternate between positively charged and negatively charged, where the radially adjacent poles are of different charges.

For an example first poles 612 and the second poles 614 may include permanent magnets, and therein the charges of the first poles 612 permanently positively or negatively charged and the second poles 614 may be permanently negatively or positively charged, unless demagnetized. However, it is to be appreciated for another example the magnets of the first poles 612 and the second poles 614 may be electromagnets. If including electromagnets, the charges of first poles 612 and the second poles 614 may alternate in sequence over a period of time between being negatively and positively charged.

A first set of magnets may be loaded into the first and second slots 562, 564, where a plurality of over-molds may be wrapped around, rigidly coupled, and bonded to the stack 434. The over-modes filled the volumes of the first and second slots 562, 564 around the first set of magnets. Likewise, a second set of magnets may be loaded into the third and fourth slots 566, 568, where a plurality of other over-molds may be wrapped around, rigidly coupled to, and bonded to the stack 434. The other over-molds fill the volumes of the third and fourth slots 566, 568 around the second set of magnets. Each of first poles 612 may include a first set of magnets and second set of magnets, and each of the second poles 614 may include a second set of magnets, where the first and second sets of magnets of the first poles are of opposite charges (e.g., oppositely charged) from the first and the second sets magnets of the second pole.

Flow of air and other fluid through the holes 552 may cool the first set of magnets, the second set of magnets, and other magnets of the rotor via conduction through the lamination 444 and/or other laminations of the stack 434 and via convection with the air and other fluid transported through holes 552 being a heat exchange medium.

For example, the first set of magnets may include a plurality of first magnets 672 and a plurality of second magnets 674. Likewise, the second set of magnets may include a plurality of third magnets 676 and plurality of fourth magnets 678. Each of the first magnets 672 may be loaded into a slot of the first slots 562 and be wrapped via an over-mold of the second material 632 filling the voids of the first slots 562. The first magnets 672 may be rigidly coupled and bonded to the surfaces of the stack 434 surrounding the first slots 562 via the over-molds of the second material 632. The first magnets 672 may also be mechanically supported by the first members 582, where the first members 582 may prevent movements, such as sliding, of the first magnets 672. Further, composition of the second material 632 may eliminate residual magnetism from the over-molds above a threshold of magnetism.

Each of the second magnets 674 may be loaded into a slot of the second slots 564 and be wrapped via an over-mold of the second material 632 filling the voids of the second slots 564. The second magnets 674 may be rigidly coupled and bonded to the surfaces of the stack 434 surrounding the second slots 564 via the over-molds of the second material 632. Each of the first magnets 672 and the second magnets 674 may be separated by the first angle 570, and therein each of the first magnets 672 and the second magnets 674 are arranged in V-shaped pairs. The second magnets 674 may also be mechanically supported by the second members 584, where the second members 584 may prevent movements, such as sliding, of the second magnets 674.

Each of the third magnets 676 may be loaded into a slot of the third slots 566 and be wrapped via an over-mold of the second material 632 filling the voids of the third slots 566. The third magnets 676 may be rigidly coupled and bonded to the surfaces of the stack 434 surrounding the third slots 566 via the over-molds of the second material 632. The third magnets 676 may also be mechanically supported by the third members 586, where the third members 586 may prevent movements, such as sliding, of the third magnets 676. Each of the fourth magnets 678 may be loaded into a slot of the fourth slots 568 and be wrapped via an over-mold of the second material 632 filling the voids of the fourth slots 568. The fourth magnets 678 may be rigidly coupled and bonded to the surfaces of the stack 434 surrounding the fourth slots 568 via the over-molds of the second material 632. The fourth magnets 678 may also be mechanically supported by the fourth members 588, where the fourth members 588 may prevent movements, such as sliding, of the fourth magnets 678. Each of the third magnets 676 and the fourth magnets 678 may be separated by the second angle 572, and therein each of the third magnets 676 and the fourth magnets 678 are arranged in V-shaped pairs. The magnets of the stack 434 and other magnets of the rotor may be permanent magnets.

The over-molds of the second material 632 may prevent surface sharing contact between the stack 434 and the first magnets 672, the second magnets 674, the third magnets 676, and the fourth magnets 678. The over-molds of the second material 632 may prevent an electrically and magnetically conductive material comprising the stack 434, such as electrical steel, from contacting or covering axially the magnets of the rotor 204, such as the first magnets 672, the second magnets 674, the third magnets 676, and the fourth magnets 678. Covering axially, may refer to covering ends and surfaces of the magnets normal to an axis parallel with the rotational axis, such as the first axis 299. As a plastic polymer, the second material 632 may eliminate or reduce residual magnetism and have lesser permeability compared to other non-magnetic materials. The over-molds of the second material 632 may therein reduce magnetic interference, such as flux leakage, between the magnets, such as the magnets 672, 674, 676, and 678, and the lamination(s) of the stack 434. Additionally, the over-molds of the second material 632 may reduce or eliminate magnetic interference between the magnets and the over-molds.

The second material 632 may be connected to and continuous with first material 532. Said in another way, the first material 532 and the second material 632 may be joined and continuously connected. The first material 532 and second material 632 may be joined via bonding, such as via polymeric and other molecular bonding. Said in another way, the first material 532 and the second material 632 may be bonded.

The first material 532 and the second material 632 may be first added in a liquid or another fluid state to the pockets for housing magnets of the stack 434, such as the slots 562, 564, 566, 568. The first material 532 may be added to the first grooves 528 and a molding tool to form the fins 456 via injection. Likewise, the second material 632 may be added to the stack 434 and the pockets thereof to form the over-mold via injection. After being added to the pockets, the first material 532 may be extruded into a plurality of cavities a mold or mold tool and the first grooves 528. The mold or mold tool interfaces and arranged around the collar 452, more specifically, the mold or mold tool is arranged so that the cavities are in volumetrically communication (e.g., volumetrically continuous with) the first grooves 528. Even more specifically, the first grooves 528 and the cavities of the mold tool are arranged to form the approximate volume of the fins 456.

Therein, inventors have developed a configuration of a solution that includes a rotor core assembly comprising: a first stack of laminations; a second stack of laminations; a first collar, where the first collar is rigidly coupled to the first stack; a second collar, where the second collar is rigidly coupled to the second stack; and an air pump assembly, the air pump assembly is formed via at least the first collar, and the air pump assembly including a plurality of fins comprised of a molded material bonded to, rigidly coupled thereto, and that extend radially from the first collar, where the air pump assembly is arranged between the first stack and the second stack. The first collar and second collar may comprise a common material as and have an approximately same coefficient of thermal expansion as the first stack and the second stack. The first stack and the second stack are loaded with a plurality of magnets. The magnets are loaded into and housed via pockets that may be slots. And each of the magnets may be rigidly coupled and bonded to their respective stacks of laminations via an over-mold of non-magnetic material. Where the fins are moldable and bondable to the over-molds. And, where the fins and the over-molds are comprised a polymer resin material, such that residual magnetism is eliminated from the fins and over-molds. Further the polymer resin of the over-molds prevents magnetic interferences, such as flux leakage, between the magnets and the stacks, collars, and/or material of the over-mold.

Further, FIGS. 1-6 of the disclosure provides support for an electric machine comprising: a rotor core assembly, the rotor core assembly comprising: a first stack of laminations, a second stack of laminations, a collar, the collar rigidly coupled to the first stack, and an air pump assembly, the air pump assembly comprising an air pump with a plurality of fins comprised of a molded material bonded to, rigidly coupled to, and that extend radially from the collar, and the air pump is arranged between the first stack and the second stack, a stator, and an air gap, wherein the air gap arranged between the stator and the rotor core, and the air gap is arranged between the stator and the air pump.

In a first example of the system, the collar is a first collar and the rotor core assembly comprises a second collar, wherein the second collar is rigidly coupled to the second stack and the first collar. In a second example of the system, optionally including the first example, a plurality of first fins are attached to the first collar, and a plurality of second fins are attached to the second collar. In a third example of the system, optionally including one or both of the first and second examples, wherein the first collar and the second collar are bonded via bonding the fins to the first collar and the second collar. In a fourth example of the system, optionally including one or more or each of the first through third examples, wherein the first collar is rigidly coupled to a plurality of first stacks and the second collar is bonded to a plurality of second stacks. In a fifth example of the system, optionally including one or more or each of the first through fourth examples, wherein the first stack, and the second stack comprise a common material and have approximately the same coefficient of thermal expansion. In a sixth example of the system, optionally including one or more or each of the first through fifth examples, wherein the fins are bonded to the collar and bonded to the first stack. In a seventh example of the system, optionally including one or more or each of the first through sixth examples, the fins are bonded to molded material filling a plurality of pockets of the first stack. In an eighth example of the system, optionally including one or more or each of the first through seventh examples, wherein the pockets house a plurality of magnets, and the molded material bonds and rigidly couple the magnets to first stack. In a ninth example of the system, optionally including one or more or each of the first through eighth examples, wherein the molded material is a resin, and the fins comprise resin. In a tenth example of the system, optionally including one or more or each of the first through ninth examples, wherein the collar includes a plurality of grooves, where the fins are inset and housed via the grooves. In an eleventh example of the system, optionally including one or more or each of the first through tenth examples, the collar includes a plurality of grips around the fins providing a form lock between the molded material of the fins and the collar.

Turning to FIG. 7 shows a flow chart of a method for manufacturing the rotor assembly with the air pump section therewithin. The method includes the process of creating the fins for the pumping section via a molding tool.

Method 700 begins at 702 and includes preparing the first collar of the rotor core. The first collar may be prepared via assembly or partially assembly. The first collar may comprise a plurality of laminations, referred to herein as first collar laminations. For example, the first collar laminations may be aligned, such as to be radially around a common axis and such that a plurality of features, such as groove and grips, are approximately super-imposed forming a grooves and grips that extend along the length of the first collar. The first collar may be the first collar 452a or the second collar 452b of FIG. 5. Further preparations may include rigidly coupling the components comprising the first collar. For an example, the first collar may be rigidly coupled via bonding by a molding material and/or a coating applied between each of the first collar laminations. For another example, the first collar laminations of the first collar may be rigidly coupled via a removable device, such as a mount, a clamp, or another coupling tool.

Method 700 continues 712 and includes securing a first collar of the rotor core in a position. The first collar is secured via a device, such as a fixture, where the first collar is rigidly coupled to the device.

Method 700 continues 714, where 714 is an optional step, including rigidly coupling one or more of a first set of first stack(s), that may be referred to herein additionally or alternatively as A-stacks, to the first collar. For an example, the A-stacks may be the first and second A-stacks 432a, 432b of FIG. 4A. The A-stacks are added in sequence, and may be translated along and around the first collar. The A-stacks may be rigidly coupled to the first collar via a tongue and groove arrangement. The A-stacks may comprise one or more laminations. Before coupling to the first collar, the laminations may be preassembled. The A-stacks may be rigidly coupled via a removable device, such as a mount, a clamp, or another tool.

Method 700 continues to 716, and includes rigidly coupling a second stack, referred to herein additionally or alternatively as a B-stack, to the first collar. The B-stack may be the first B-stack 434a of FIGS. 4A-4B. The B-stack may be translated along and around the first collar. After rigidly coupling the B-stack, the B-stack and the first collar form a first stack assembly, referred to herein as a first assembly herein. The B-stack may be rigidly coupled via a removable device, such as a mount, a clamp, or another tool.

Method 700 continues to 722, and includes arranging a molding tool around a section of the first collar having a plurality of grooves and grips. A first section of the collar extending along a rotational axis from the first stack assembly, includes the grooves and the grips. The section is arranged such that the molding tool is positionable around the section.

Method 700 continues to 724, and includes preparing molding tool and the section for application of a material in a fluid form for molding. The molding tool and the section are prepared via aligning a plurality of cavities of the molding tool with the grooves of the section, such that the grooves and the cavities are in volumetric communication and form a mold for each of the plurality of fins. Said in another way the grooves and cavities are aligned forming a plurality of molds for the fins.

Method 700 continues to 726, and includes loading a plurality of magnets to the first assembly, such as to be housed via the second stack and/or first stack(s). The magnets may be the first magnets 672, the second magnets 674, the third magnets 676, and/or the fourth magnets 678. The magnets may be housed via a plurality of pockets, and the pockets may be slots, such as the first slots 562, the second slots 564, the third slots 566, and/or the fourth slots 568 of FIG. 5. When inserted, the magnets may be secured via a loading tool preventing or reducing movement, such as sliding, of the magnets within the pockets. Further the loading tool may arrange the magnets preventing contact between the magnets and a surface of the respective stacks the magnets are loaded in. Said in another way, the loading tool may load the magnets such that that there are voids between the magnets and surfaces of stacks surrounding pockets housing the magnets occupy.

Method 700 continues to 728, where molding material is applied to the stack to rigidly couple and adhesively bond the magnets to surfaces of the B-stack and/or A-stack(s) around the pockets and form the fins. 726 is comprised of a plurality of sub-steps, including 730, 732, 734, 736.

At 730, the method 700 starts applying the molding material in a liquid or another fluid form to fill the pockets housing the magnets. The molding material may be a foam. The molding material may be applied at an opening or a plurality of openings fluidly coupled to the pockets. The molding material may be inserted and applied at a first end of the second stack or an end of a set of second stack opposite to a second end of the second stack, where the first collar extends from the second end. The molding material may be injected to the one or more stacks of laminations adjacent to, contacting, and fluid communication with the second stack and part of first stack assembly, to fill the pockets. Filling continues until the volume of the pockets around the magnets are filled via the molding material. During and after filling, the material may surround the magnets and may prevent contact between the magnets and surfaces of the second stack and/or the first stack(s) surrounding the pockets.

At 732, method 700 continues by adding the molding material to the molds formed by the cavities of the molding tool and the grooves of the first collar. A first section of the collar extending from the second stack includes the grooves. Filling continues until the molds for the fins are filled via the molding material. It is to be appreciate that the pockets and molds are fluidically coupled and/or in fluid communication via one or more openings of the second stack or the first stack(s). A common molding material used to fill the pockets at 730 and the molds at 732.

It is to be appreciated that 730 and 732 may be completed in reverse order compared to the example in FIG. 7. Further, applying the fluid to fill the pockets at 730 may fill the molds with molding material at 732, and vice versa. For example, filling the pockets with molding material at 730 may be accomplished by extruding molding material from the molding tool, and the molds therein, into the openings fluidly coupled to the pockets second stack. For another example, filling the molds with molding material at 732 may be accomplished by extruding molding material from the second stack and the pockets therein, and into openings of the molding tool fluidly coupled to or in fluid communication with the molds.

At 734, method 700 continues by joining the molding material housed by the pockets of the second stack and/or first stack(s) and the molds of the collars and the molding tool. The molding material may be joined via 730, where the molding material is added to the molds from the pockets. It is to be appreciated, that 734 may be completed as a part of 730 and 732, such as if a molding material is extruded from the pocket to the molds or vice versa.

It is to be appreciated that 730, 732, and 734 may include applying molding material to the spaces between laminations of the first collar and other feature therein, such as grooves and holes. For example, applying molding material at 730 and 732 and/or extruding the molding material at 734 applies a molding material between the first collar and the second stack and/or the first stack(s), such as to rigidly couple the first collar to the second stack and/or the first stack(s) via adhesive bonding. For this or another example, applying molding material at 730 and 732 and/or extruding the molding material at 734 applies a molding material to the first collar laminations and the gaps therebetween, such as to rigidly couple the first collar laminations via adhesive bonding. For another example, adding the molding material to the molds of the mold tool at 732 and extruding the molding material from the molding tool at 734 applies molding material around the first collar to be adhesively bonded to the second stack and/or the first stack(s), and rigidly coupling the first collar and second stack and/or the first stack(s) therein. Further, adding molding material to the molds of the mold tool at 732 and extruding the molding material from the molding tool at 734 applies molding material to grooves and spaces between the first collar laminations, to be adhesively bonded, rigidly coupling the laminations therein.

At 736, method 700 continues by curing the molding material into a solid. After curing, the molding material becomes molded material, forming fins from the molding material that fills the molds. The fins formed via curing extend from the first section of the first collar. Further curing may create additional bonds between the material housed via the pockets and the material forming the fins After curing, method 700 continues 738, removing the molding tool. Further at 738, other tools may be removed from the rotor and components housed within, such as the loading tool described at 726. Further the curing may create and/or strengthen rigid coupling between the first collar laminations of the first collar, for example, by creating adhesive bonds between each of the first collar laminations and the molding material, and creating stronger polymeric bonds through the molding material extending therebetween and therethrough. After strengthening via forming polymeric bonds, the molding material may mechanically support the first collar and the first stack or first stacks, increasing sheer, tensile, and compressive strength of the first stack assembly after curing.

Method 700 continues to 740, and includes preparing the second collar of the rotor core. The second collar may be prepared via assembly or partially assembly. The second collar may comprise a plurality of laminations, referred to herein as a second collar laminations. For example, the second collar laminations may be aligned, such as to be radially around a common axis and such that a plurality of features, such as groove and grips, are approximately super-imposed forming a grooves and grips that extend along the length of the second collar. For example, the second collar may be the second collar 452b when the first collar is the first collar 452a. For another example, the second collar may be the first collar 452a when the first collar is the second collar 452b.

Further preparations of the second collar at 740, may include rigidly coupling the components comprising the second collar. For an example, the second collar may be rigidly coupled via bonding by a molding material and/or a coating applied between each of second collar laminations. For another example, the second collar laminations may be rigidly coupled via a removable device, such as a mount, a clamp, or another coupling tool.

At 742, method 700 continues by repeating the steps of 712-738 for a second collar and a second set of stacks. The second set of stacks may be referred to herein as a second stack assembly when rigidly coupled to the collar formed thereby. The second stack assembly may include at least a fourth stack and optionally a plurality of third stacks arranged and stacked in sequence. For example, second stack assembly is formed via the fourth stack to be arranged adjacent to the pump, such as a B-stack, such as the second B-stack 434b of FIGS. 4A-4B. Optionally one or more of a plurality of third stacks may rigidly couple the second collar as described in 714. The third stacks may be A-stacks, such as the third and fourth A-stacks 432c, 432d of FIG. 4A.

Further while repeating the steps of 712-738 at 742, the grooves described for the first collar are a plurality of first grooves, cavities are a plurality of first cavities, the mold forms are a plurality of first mold forms, the fins are a plurality of first fins, the pockets are a plurality of first pockets. Further the second stack assembly and second set of stack therein, including the third stacks and optionally the fourth stacks, includes a plurality of second pockets analogous to the first pockets. Further the second collar includes a second section analogous to the first section, a plurality of second grooves analogous to the first grooves, a plurality of second mold forms analogous with the first mold forms. Analogous components and features between the first set of stacks and second set of stacks and/or the first collar and second collar may be symmetrical and mirrored, but non-reversable. Repeating the steps of 712-738 for the second stack assembly and collar, loads the second cavities with magnets, fills the second cavities with filling material, fills the second molds created between the second grooves and the second mold forms of the second molding tool with filling material, joins the filling material filling the second pockets and the second mold forms via bonding, cures and creates additional bonds between the filling material of the second pockets and the second molding forms, cures and forms the second fins, and removes the second molding tool.

It is to be appreciated, that the second molding tool for 742 may be the first molding tool reused. Further it is to be appreciated, that steps of 702-738 for preparing the first collar creating the first stack assembly, rigidly coupling the first stack assembly to the first collar, loading and molding the magnets into the first pockets the first stack assembly, and molding the first fins of the first section may be completed simultaneously as 742 and repeating the steps of 712-738 for the second stack assembly and the second collar.

Method 700 continues to 744, rigidly coupling the first collar to the second collar, forming a rotor assembly therein. The first collar and the second collar are rigidly coupled to via their first and second air pump sections, respectively, forming an air pump. The air pump formed via the coupling is sandwiched between the B-stacks (e.g., the second stack and fourth stack) of each of the first and the second stack assemblies.

Therein the inventors have developed a method of assembling a rotor having an air-pump between at least two stacks, rigidly couple and bond magnets to stacks of the rotor via over-molds of a polymer resin, form the fins of the air pump via a polymer resin, and join the material of the fins and the material of the over-molds via bonding.

The method may decrease assembly times, such as assembly cycle times, compared to rotors that include dedicated air pump as a separate component from collars supporting the rotor stacks, such as an air pump shim. Further the manufacturing method may reduce the number of materials to manage (e.g., bill of material to manage) compared to systems with air pump comprising separate components from collars supporting the rotor stack. The method may remove materials, such as aluminum, with different coefficients of thermal expansion from components and features of laminations and other components of the rotor stack.

The disclosure also provides support for a method of assembling a rotor core, comprising: securing and centering a collar around an axis, where the collar is a rotor core collar coupleable to one or more stacks of laminations of the rotor core, coupling a first stack of laminations to the collar, via translating the first stack around the collar along the axis, and securing the first stack to a position around the collar and the axis preventing further translation therein, arranging a molding tool around a section of the collar exposed from the first stack, where the section extends along and is centered around the axis from an end of the first stack, aligning the molding tool such that a plurality of cavities of the molding tool are in volumetric communication with a plurality of grooves of the collar and pockets of the first stack, each of the cavities and the grooves create mold forms in a desired shape for a plurality of fins arrange radially around the section, and a plurality of holes are in fluid communication with gaps radially between the cavities, filling the pockets of the first stack with a molding material, filling the mold forms created between the cavities and the grooves with the molding material, bonding the molding material filling volumes first stack and volumes of collar and the molding tool, more specifically bonding the molding material filling the cavities and the mold forms, curing the molding material until the molding material housed via the mold forms has solidified into a molded material forming into the fins, where the fins are extending radially from the section, removing the molding tool from around the section and the fins, arranging a second stack radially around the axis, sandwiching the section between the first stack and the second stack, and rigidly coupling the first stack to the second stack via the section, forming and sandwiching an air pump therebetween the first stack and the second stack from the section and the fins.

Turning to FIG. 8, it shows a flow chart of method 800 for removing a fluid from an air gap between the stator and rotor via the pump section. The air gap is open to and in fluid communication with the air gap via another gap between the at least a first stack and a second of stack of the rotor on opposite sides of the pumping section. Method 800 may be used for a rotor of the present disclosure, such as a rotor 204 of FIGS. 2-4, wherein the air gap may be the air gap 308, the other gap may be the gap 430, the stacks of laminations may include the first stack 331a and second stack 331b of FIG. 3 or the first stacks 426 and second stacks 428 of FIG. 4A-4B, and the pump section may be the air pump section 314 and/or include the air pump 451. Additionally, method 800 may pump fluid collected via suction from the air pump section through the rotor and one or more stacks thereof for cooling, lubrication, and/or hydraulic applications.

Method 800 begins at 802, where the rotor is rotated and the rotational speed (e.g., synchronous speed) of the rotor is increased to or above a first non-zero threshold of rotational speed (e.g., a threshold non-zero speed). The rotor may be part of a larger electric machine such as the electric machine 106 of FIGS. 1-3. For example, the rotor may be rotated via a stator, such as the stator 206 of FIGS. 2-3, of the electric machine, and more specifically by magnetic interaction, including magnetic flux, from magnetic fields between the stator and the rotor. The stator is located around the rotor, and the air gap around the rotor and sandwiched between the rotor and stator. More specifically, the rotor may be loaded with magnets, such as permanent magnets, and the stator may be loaded with electrical windings. Current, such as alternating current, through the electrical windings may induce magnetic flux placing a magnetic force on the magnets housed via the rotor. The magnetic forces may generate torque causing the rotor to rotate. The rotor may spin around an axis, such as the first axis 299. Increasing, the frequency of the alternate current supplied may increase the rotational speed (e.g., synchronous speed) of the rotor. After the rotor has reached or surpassed the first threshold of rotational speed, a liquid and/or other fluid may be sprayed, dripped, splashed, or flowed by other means through the air gap and around the pump. The liquid and/or other fluid may be a lubricant and/or heat exchange medium, such as oil, that may lubricate and/or remove or add thermal energy to the rotor. For example, as a heat exchange medium, the liquid and/or other fluid may be a coolant and the heat exchange fluid described via the specification of FIG. 3. Said in another way, after increasing above the first threshold of rotational speed, liquid and/or other fluid may and be transported between the air gap to lubricate and/or cool the rotor and stator.

Method 800 continues to 804, generating and increasing an air flow through the air pump via rotation of the air pump. 804 further includes generating suction via the air flow through the air pump. More specifically, the rotation of the fins may generate the air flow or flow of another gaseous fluid (e.g., gaseous fluid flow), pushing air and other gaseous fluid radially outward. The air flow may pass through the air gap and between the fins of the air pump. The flow of air may generate a blowing force between both the air gap and the air pump and along the spaces between the fins of the air pump. The air flow and blowing force may occur approximately instantaneously as the rotor reaches and/or surpasses the first non-zero threshold of rotational speed. Alternatively, the air flow and blowing may occur after a first threshold of time from the rotor reaching or surpassing the first non-zero threshold of rotational speed.

Method continues to 806, creating suction at holes of the rotor open to the air pump. Gaseous fluid flow from between the fins outward creates lowers the pressure of air around the volumes between the fins. The lower pressure may pull air and other gaseous fluid theretoward, such as from near the holes creating the suction therein. The suction pulls air and/or other gaseous from the holes of the rotor and rotor core in fluid communication with the air pump. The suction may occur after the airflow and/or gaseous fluid flow increases above a second threshold of a volumetric flow and a third threshold of a pressure differential (ΔP). The third threshold is for a pressure differential between the volume of the air pump and the first openings to the holes. The holes include at least a plurality of first holes stack of lamination stack. The holes may include other holes of other laminations stacks, such as a plurality of second holes of a second lamination stack. For example, gaseous fluid may be pumped from holes of the of stacks of the rotor core with openings facing the air pump and spaces between the blades of the air pump. The holes may be arranged opposite sides of the air pump, where the air pump is sandwiched between the lamination stacks. The holes may be through holes extending through their respective stacks and being open to ends of their respective stacks opposite first end of a respective stack facing the air pump.

For example, the air pump may be arranged between the first stack and the first holes thereof and a second stack and the second holes thereof. Further the holes may have centerlines parallel with a rotational axis of the rotor. The holes may be connected to other fluid passages and volumes of their respective stacks and of the rotor. For example, the holes may be the first channels 324 or the second channels 325 of FIG. 3, or the holes 552 of FIGS. 5-6. The suction through the holes pumps air and other gasses out from between the fins of the air pump, continuing the airflow and suction from the air pump. As the rotational speed of the rotor and air pump increases, the air flow to and through the air pump and the suction of the air pump increases. Additionally, as the air flow to and through the air pump increases and the suction of the air pump increase, the force of suction increases generated at the openings to the holes. Thus the airflow through and suction generated via the air pump and the holes is proportional to the rotational speed of the rotor.

Method 800 continues to 808, drawing gaseous fluid, such as air, into and through the holes of the rotor toward the air gap. Further, aerosolized liquid, may be driven by suction along with the gaseous fluid. More specifically, 808 includes drawing from first openings of the holes facing outward from ends of the rotor that are away from the air gap toward second openings of the holes facing inward toward the air gap and the air pump. The air gap between the rotor and the stator toward the air pump and between the stacks of the rotor, via the suction and airflow and/or gaseous fluid flow generated via the air pump. Pumping of fluid into the holes from one or more first openings may occur after the airflow and/or gaseous fluid flow increases above a fourth threshold of a volumetric flow and the pressure differential increases above a fifth threshold of a pressure differential. Pumping the air and/or gaseous fluid toward the air pump through the holes ensures that the airflow is continuously replenished and blown into the air gap as the rotor rotates. It is to be appreciated, that the fourth threshold of volumetric flow may be approximately equal to the second threshold of volumetric flow. The fifth threshold may be for a pressure differential between the first openings of the holes and the second openings of the holes.

The airflow and/or gaseous fluid may provide a heat exchange function, where the air and/or other gaseous fluid is a heat exchange medium cooling material and surfaces of the stacks around the holes via conduction and convection. For example, the suction through the holes may pull a continuous stream of air and other gaseous fluid to be warmed via heat exchange with rotor, cooling the rotor and magnets therein. The warmed air or gaseous fluid may exit a stack at the air pump, being removed and blown outward toward the air gap. For another example, the suction through the holes may pull a continuous stream of air and other gaseous fluid to be cooled via heat exchange with rotor, warming the rotor. The cooled air or gaseous fluid may exit a stack at the air pump, being removed and blown outward toward the air gap.

Method 800, continues to 810, drawing gaseous fluid from the holes between the fins of the air pump. When drawn between the fins, the method 800 continues pushing liquid along the widths of the fins in the spaces there between. Method 800 continues to 812, pushing gaseous fluid in an outward direction from the air pump toward the air gap between the stator and rotor. The pushing of the gaseous fluid through the air gap from the air pump creates a pressure wave and a blowing force.

Method 800 continues to 814, increasing pressure of the gaseous fluid above a first threshold of pressure and the blowing force from the gaseous fluid above a second threshold of force (e.g., a threshold non-zero force), and pushing accumulated liquid occupying the air gap out from the air gap via the blowing force. Said in another way, the method 800 at 814 includes pushing liquid occupying the air gap and a trapped between the rotor and stator out therefrom via the gaseous fluid pushed out of the air pump. The liquid may be lubricant and/or heat exchange fluid that has accumulated in the air gap. See the accumulated fluid 358 of FIG. 3. The second threshold of force is greater than the adhesive force between liquid and the stator and rotor and the centripetal force preventing flow of the liquid out of the air gap. When driving the rotor via the stator or by other means, removing the liquid from occupying the air gap and/or from contact with stator and the rotor may decrease power losses compared to when the liquid occupies the air gap.

The pumping of the air pump may at least drive gaseous fluid and the liquid around stack of a rotor core and the rotor, providing cooling via conduction through contact and via convection through the fluid flow.

After the fluid pumped to and liquid occupying the air gap leaves the air gap via the pumping of fluid and blowing force therefrom, method 800 ends.

Therein the inventors have developed a method of removing a fluid from the air gap between the stator and rotor via the pump section comprising a plurality of fins extending radially outward from one or more collars, where the fins further comprise a polymer that may be joined via bonding to over-molds rigidly coupling a plurality of magnets to a rotor core of the rotor. During the method, rotation of the pump section via rotation of the rotor passively generates airflow and suction, removing liquid from the air gap and pumping the liquid from the pump section through a plurality of holes of two or more stacks of the rotor assembly, and where the stacks are arranged on opposite sides of the air pump.

The disclosure also provides support for an electric machine comprising: a rotor core assembly, the rotor core assembly comprising: a first stack of laminations, a second stack of laminations, a collar, the collar rigidly coupled to the first stack, and an air pump assembly, the air pump assembly comprising a plurality of fins comprised of a molded material bonded to, rigidly coupled to, and that extend radially from the collar, and the air pump is arranged between the first stack and the second stack, a stator, and an air gap, wherein the air gap arranged between the stator and the rotor core, and the air gap is arranged between the stator and the air pump.

In a first example of the system, the collar is a first collar and the rotor core assembly comprises a second collar, wherein the second collar is rigidly coupled to the second stack and the first collar. In a second example of the system, optionally including the first example, a plurality of first fins are attached to the first collar, and a plurality of second fins are attached to the second collar. In a third example of the system, optionally including one or both of the first and second examples, wherein the first collar and the second collar are bonded via bonding the fins to the first collar and the second collar. In a fourth example of the system, optionally including one or more or each of the first through third examples, wherein the first collar is rigidly coupled to a plurality of first stacks and the second collar is bonded to a plurality of second stacks. In a fifth example of the system, optionally including one or more or each of the first through fourth examples, wherein the first stack, and the second stack comprise a common material and have approximately the same coefficient of thermal expansion. In a sixth example of the system, optionally including one or more or each of the first through fifth examples, wherein the fins are bonded to the collar and bonded to the first stack. In a seventh example of the system, optionally including one or more or each of the first through sixth examples, the fins are bonded to molded material filling a plurality of pockets of the first stack. In an eighth example of the system, optionally including one or more or each of the first through seventh examples, wherein the pockets house a plurality of magnets, and the molded material bonds and rigidly couple the magnets to first stack. In a ninth example of the system, optionally including one or more or each of the first through eighth examples, wherein the molded material is a resin, and the fins comprise resin. In a tenth example of the system, optionally including one or more or each of the first through ninth examples, wherein the collar includes a plurality of grooves, where the fins are inset and housed via the grooves. In an eleventh example of the system, optionally including one or more or each of the first through tenth examples, the collar includes a plurality of grips around the fins providing a form lock between the molded material of the fins and the collar.

The disclosure also provides support for a first method of a removing liquid from a first air gap between a rotor and a stator comprising: rotating the rotor at or above a threshold non-zero speed, where the rotor comprises a first stack of laminations and a second stack of laminations with an air pump therebetween, where the air pump includes a plurality of fins extending radially from a collar, where the collar is rigidly coupled to and extends from the first stack, and the fins are joined to molded material housed via pockets of the first stack, generating an airflow through a plurality of second air gaps between the fins via rotating the rotor, creating suction between the fins, creating suction at a plurality of first holes of the first stack in fluid communication with the second air gaps between the fins via the airflow, pumping gaseous fluid through the first stack through the first holes via the airflow and suction toward the air pump, pumping gaseous fluid from the first holes and outward from the pump with a blowing force greater than another threshold non-zero force, and blowing liquid occupying the air gap out of the air gap and out of contact with the stator and rotor. In a first example of the first method, the first method further comprises: generating suction via a plurality of second holes of the second stack and separate from the first holes, pumping gaseous fluid into the second holes, and pumping gaseous fluid through the second stack via the second holes. In a second example of the first method, optionally including the first example, the first method further comprises: pumping gaseous fluid through a plurality of first stacks, where a plurality of sets of first holes extend through each of the first stacks, and each of the sets are aligned such that gaseous fluid is pumped via suction through the first stacks. In a third example of the first method, optionally including one or both of the first and second examples, the first method further comprises: cooling the first stack and magnets housed via the first stack via pumping gaseous fluid through the first holes. In a fourth example of the first method, optionally including one or more or each of the first through third examples, liquid occupying the air gap is oil lubricating and cooling the rotor.

In a first example of the second method comprising inserting a plurality of magnets to be housed via the pockets of the first stack, filling the volumes of the pockets around the magnets with molding material, and bonding the magnets to the first stack via the molding material, where the molding material is a resin. In a second example of the second method, optionally including the first example, comprising assembling the collar from a plurality of other laminations.

In another representation, a third example of the second method, optionally including one or both of the first and second examples, the second method further comprising inserting a plurality of magnets to be housed via the pockets of the first stack, filling the volumes of the pockets around the magnets with molding material, and bonding the magnets to the first stack via the molding material, where the molding material is a resin. In another representation, a fourth example of the second method, optionally including one or more or each the first through third examples, the resin is a foam. In another representation, a fifth example of the second method, optionally including one or more or each of the first through fifth examples, further comprising repeating steps for rigidly coupling the second stack and a second collar and forming a plurality of second fins as part of the air pump, where the collar is a first collar and the section therein is a first section, the grooves are a plurality of first grooves, cavities are a plurality of first cavities, the mold forms are a plurality of first mold forms, the fins are a plurality of first fins, the pockets are a plurality of first pockets, where the second stack includes a plurality of second pockets analogous to the first pockets, and the second collar includes a second section analogous to the first section, a plurality of second grooves analogous to the first grooves, a plurality of second mold forms analogous with the first mold forms, and the second method comprises rigidly coupling the first section the second section between the first stack and the second stack. In another representation, in a sixth example of the second method, optionally including one or more or each of the first through third examples, further comprising joining the first section and the second section, and joining the first fins to the second fins via adhesive bonding. In another representation, in a seventh example of the second method, optionally including one or more or each of the first through fourth examples, further comprising extruding the molding material from the pockets to fill the mold forms. In another representation, in an eighth example of the second method, optionally including one or more or each of the first through fifth examples, further comprising extruding molding material from the mold forms to fill the pockets. In another representation, in a ninth example of the second method, optionally including one or more or each of the first through sixth examples, wherein the collar comprises electrical steel

FIG. 1 and FIG. 3 show schematic representations of example configurations of systems with relative positioning of the various components. FIG. 2 and FIGS. 4A-6 show example configurations with approximate position, unless otherwise specified with components or features described as being schematics or being shown schematically. FIG. 2 and FIGS. 4A-6 are shown approximately to scale, unless otherwise specified with components or features described as being schematics or being shown schematically; though other relative dimensions may be used. As used herein, the terms “approximately” is construed to mean plus or minus five percent of the range unless otherwise specified. As used herein, the term “approximately” is construed to mean plus or minus five percent of the range, unless otherwise specified.

FIGS. 1-6 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. It will be appreciated that one or more components referred to as being “substantially similar and/or identical” differ from one another according to manufacturing tolerances (e.g., within 1-5% deviation).

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An electric machine comprising:
a rotor core assembly, the rotor core assembly comprising:
a first stack of laminations;
a second stack of laminations;
a collar, wherein the collar rigidly couples to the first stack; and
an air pump assembly, the air pump assembly comprising an air pump with a plurality of fins comprised of a first molded material bonded to, rigidly coupled to, and extended radially from the collar, wherein the air pump is arranged between the first stack and the second stack and in fluid communication with holes of the first stack and the second stack;
a stator; and
an air gap, wherein the air gap arranged between the stator and the rotor core assembly, and the air gap is arranged between the stator and the air pump.

2. The electric machine of claim 1, wherein the collar is a first collar and the rotor core assembly comprises a second collar, where the second collar rigidly couples to the second stack and the first collar.

3. The electric machine of claim 2, wherein the plurality of fins includes a plurality of first fins attached to the first collar and a plurality of second fins attached to the second collar.

4. The electric machine of claim 2, wherein the first collar is rigidly coupled to a plurality of first stacks and the second collar is rigidly coupled to a plurality of second stacks.

5. The electric machine of claim 1, wherein the collar, the first stack, and the second stack each comprise a common material having approximately the same coefficient of thermal expansion.

6. The electric machine of claim 1, wherein the fins are adhesively bonded to the collar and adhesively bonded to the first stack.

7. The electric machine of claim 6, wherein the fins are joined to a second molded material filling a plurality of pockets of the first stack via bonding.

8. The electric machine of claim 7, wherein the pockets house a plurality of magnets, and the second molded material bonds and rigidly couples the magnets to the first stack.

9. The electric machine of claim 8, wherein the magnets are covered via the second molded material preventing contact between the magnets and the first stack and preventing contact between the magnets and the collar, in an axial direction parallel with an axis of rotation of the rotor.

10. The electric machine of claim 7, wherein the first molded material and the second molded material are a common molded material sharing approximately the same composition.

11. The electric machine of claim 1, wherein the collar includes a plurality of grooves, where the fins are inset and housed via the grooves.

12. The electric machine of claim 1, wherein the collar includes a plurality of grips around the fins providing a form lock between the molded material of the fins and the collar.

13. A method of a removing liquid from a first air gap between a rotor and a stator comprising:
rotating the rotor at or above a threshold non-zero speed, where the rotor comprises a first stack of laminations and a second stack of laminations with an air pump therebetween, where the air pump includes a plurality of fins extending radially from a collar, where the collar is rigidly coupled to and extends from the first stack, and the fins are joined to molded material housed via pockets of the first stack;
generating an airflow through a plurality of second air gaps between the fins via rotating the rotor, creating suction between the fins;
creating suction at a plurality of first holes of the first stack in fluid communication with the second air gaps between the fins via the airflow;
pumping gaseous fluid through the first stack through the first holes via the airflow and suction toward the air pump;
pumping gaseous fluid from the first holes and outward from the pump with a blowing force greater than threshold non-zero force; and
blowing liquid occupying the air gap out of the air gap and out of contact with the stator and rotor.

14. The method of claim 13, further comprising generating suction via a plurality of second holes of the second stack and separate from the first holes, pumping gaseous fluid into the second holes, and pumping gaseous fluid through the second stack via the second holes.

15. The method of claim 13, further comprising pumping gaseous fluid through a plurality of first stacks, where a plurality of sets of first holes extend through each of the first stacks, and each of the sets are aligned such that gaseous fluid is pumped via suction through the first stacks.

16. The method of claim 13, further comprising cooling the first stack and magnets housed via the first stack via pumping gasesous fluid through the first holes.

17. The method of claim 13, wherein liquid occupying the air gap is oil lubricating and cooling the rotor.

18. A method of assembling a rotor core, comprising:
securing and centering a collar around an axis, where the collar is a rotor core collar coupleable to one or more stacks of laminations of the rotor core;
coupling a first stack of laminations to the collar, via translating the first stack around the collar along the axis, and securing the first stack to a position around the collar and the axis preventing further translation therein;
arranging a molding tool around a section of the collar exposed from the first stack, where the section extends along and is centered around the axis from an end of the first stack;
aligning the molding tool such that a plurality of cavities of the molding tool are in volumetric communication with a plurality of grooves of the collar and pockets of the first stack, each of the cavities and the grooves create mold forms in a desired shape for a plurality of fins arrange radially around the section, and a plurality of holes are in fluid communication with gaps radially between the cavities;
filling the pockets of the first stack with a molding material;
filling the mold forms created between the cavities and the grooves with the molding material;
bonding the molding material filling volumes first stack and volumes of collar and the molding tool, more specifically bonding the molding material filling the cavities and the mold forms;
curing the molding material until the molding material housed via the mold forms has solidified into a molded material forming into the fins, where the fins are extending radially from the section;
removing the molding tool from around the section and the fins;
arranging a second stack radially around the axis;
sandwiching the section between the first stack and the second stack; and
rigidly coupling the first stack to the second stack via the section, forming and sandwiching an air pump therebetween the first stack and the second stack from the section and the fins.

19. The method of claim 18, comprising inserting a plurality of magnets to be housed via the pockets of the first stack, filling the volumes of the pockets around the magnets with molding material, and bonding the magnets to the first stack via the molding material, where the molding material is a resin.

20. The method of claim 19, comprising assembling the collar from a plurality of other laminations.
